(19) United States
(12) Patent Application Publication
(10) Pub. No.: US 2024/0249243 A1
(43) Pub. Date: Jul. 25, 2024

(54) FACILITATING GENERATION OF ITEM INSIGHTS

(71) Applicant: Microsoft Technology Licensing, LLC, Redmond, WA (US)

(72) Inventors: Torbjørn HELVIK, Oslo (NO); Mohamed Abdelwahab Mohamed WAHBALLAH, Oslo (NO); Shibashankar SAHOO, Oslo (NO); Gideon Keprono SONOIYA, NAIROBI (KE); Natalia AN, Oslo (NO); Fabien Jérémy Louis VAVRAND, Oslo (NO); Zhifei MAO, Baerum (NO); Alina ASTRAKOVA, Baerum (NO); Thor Niclas Åke KJÄLL-OHLSSON, Oslo (NO); lgor POPOV, Asker (NO); Mustafe Ahmed FARAH, Asker (NO); Andreas Schmidt JENSEN, Alleroed (DK)

(21) Appl. No.: 18/328,064

(22) Filed: Jun. 2, 2023

Related U.S. Application Data
(60) Provisional application No. 63/480,936, filed on Jan. 20, 2023.

(51) Int. Cl. G06Q 10/101

(52) U.S. Cl. CPC G06Q 10/101

(57) ABSTRACT

Methods, computer systems, computer-storage media, and graphical user interfaces are provided for facilitating generation of item insights. In embodiments, an insight request requesting an item insight(s) is obtained. Thereafter, a collaboration network insight associated with an item of content is determined. The collaboration network insight may indicate a collaboration network that includes content items related to one another and entities associated with the set of content items. An item context insight associated with the item of content may also be determined. The item context insight can indicate a status change of the item of content relative to a most recentuser view of the item of content. Based on generation of the collaboration network insight and the item context insights, such insights can be provided in association with the item of content for display.

### BACKGROUND

As the number of tasks, meetings, electronic communications, documents, and other content an individual manages continues to increase, it becomes more difficult to identify or differentiate desired content. For example, to locate a desired content item, a user typically manually initiates searches for such an item. As a result of a search, a user may be provided with various items that may be of interest based on their relevance to the search. Even with the search, however, the search results may still need to be viewed and/or analyzed to identify a particular desired item. For example, the user may need to open and review various documents to locate a desired document which can be particularly time consuming with extensive amounts of data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, directed to generating and providing item insights in an efficient and effective manner. Item insights generally refer to insights or information related to an item (e.g., a document, a file, an electronic communication, a calendar event, etc.). For example, a user may be provided an item insight about a particular file indicating that the file has been updated by a colleague since the user last accessed the file.

One example of an item insight described herein is a collaboration network insight. A collaboration network insight refers to an indication of a collaboration network (or an aspect of a collaboration network) associated with an item of content, and is sometimes referred to herein as a collaboration network indicator. A collaboration network is generally used to refer to a set of individuals or entities and items (e.g., documents, files, calendar events, electronic communications, comments, and other items of content) that are relevant to a user in regards to a particular context or endeavor. For example, content created or communicated in regards to a particular project may fall within a particular collaboration network. Another example of an item insight described herein is an item context insight. An item context insight refers to an indication of context associated with an item, and is sometimes referred to herein as an item context indicator. This context can indicate a status or state of the item such as updates or modifications associated with the item, an individual(s) or number of individuals associated with an update or modification of the item, or other contextual information regarding the item. For instance, a context indicator for an item of content that is a file might indicate that the file has been modified since the user last accessed the file. In operation, to facilitate generating and/or providing item insights in an efficient and effective manner, aspects described herein include an item insight service, as further described herein.

In accordance with generating item insights, such as collaboration network indicators and/or item context indicators, such insights can be provided to a user computing device for display to a user. In some implementations, the insights are presented via a card, which may be included in a data feed presented to the user. For example, a card to surface an item that is a document, and that is presented in a data feed, may include a collaboration network indicator indicating a particular collaboration network (or an aspect of a particular collaboration network) associated with the document. For instance, the collaboration network indicator may comprise an indication of one or more other individuals who are a part of the same collaboration network as the document. (See for example, item 610 in FIG. 6 showing an example of a collaboration network indicator in a card 604, and discussed further in connection with FIG. 6.) Alternatively or in addition, the card can include an item insight that is an item context indicator providing an insight regarding a context of the item. For instance, the item context indicator may comprise an indication that particular individuals that have contributed to the document since the user last viewed the document. (See for example, item 616 in FIG. 6 showing an example of an item context indicator in a card 604, and discussed further in connection with FIG. 6.) Advantageously, providing the item insights in an efficient manner enables a user to have a more clear view into the relevance and/or context of a particular item indicated in the user interface (e.g., via a data feed) without having to manually track down the desired data using various systems and queries thereto.

In further accordance with generating item insights, such insights can be utilized to provide new functionality of a computer system. In particular and in some implementations, an item insight determined for a particular item, such as a collaboration network insight and/or item context insight, becomes new metadata for the item. This metadata can be utilized by a computer system to process the item in new ways. For example and without limitation, an item insight for a document can be used not only for presenting the context of the document in a data feed, but also conducting a search operation, such as for use in ranking the document among other search results, or for sorting, filtering, or differentiating the document, among other documents, in a data store or as presented via a file explorer. Accordingly and advantageously, the new computing functionality enabled by the item insights improves the operation of computer systems by providing new ways to process and manage particular data. Further, an efficient and effective manner of providing or utilizing insights related to an item (for instance, within the context of data feed, a data store, a document service, a file explorer, an electronic communication service, a web search service, etc.) generates a more user-friendly experience. In particular, a user is not required to manually search for desired information via other resources or unnecessarily open and view items, thereby resulting in less utilization of computing device resources.

### BRIEF DESCRIPTION OF THE DRAWINGS

The technology described herein is described in detail below with reference to the attached drawing figures, wherein:

FIG. 1 is a block diagram of an example computer system for facilitating generation of item insights, suitable for use in implementing aspects of the technology described herein;

FIG. 2 is an example implementation for facilitating generation of item insights, via an item insight computing service, in accordance with aspects of the technology described herein;

FIG. 3 provides an example implementation for determining collaboration networks via a computing system, in accordance with embodiments of the present technology;

FIG. 4 provides an example set of rules for generating item context insights, in accordance with embodiments of the present technology;

FIG. 5 provides an example item insight service implementation in association with a data feed computing service, in accordance with embodiments of the present technology;

FIG. 6A provides an example graphical user interface including cards in a data feed, in accordance with embodiments of the present technology;

FIG. 6B provides an example graphical user interface including example cards with item insights, in accordance with embodiments of the present technology;

FIG. 6C provides an example graphical user interface of a computer system file manager including an example file item insight, in accordance with embodiments of the present technology;

FIG. 6D provides an example graphical user interface of a communications application including an example email item insight, in accordance with embodiments of the present technology;

FIG. 7 depicts a flow diagram of a first example method for programmatically generating an item insight, in accordance with aspects of the technology described herein;

FIG. 8 depicts a flow diagram of a second example method for programmatically generating an item insight, in accordance with aspects of the technology described herein;

FIG. 9 depicts a flow diagram of a third example method for programmatically generating an item insight, in accordance with aspects of the technology described herein;

FIG. 10 is a block diagram of an example computing environment suitable for use in implementing aspects of the technology described herein; and

FIG. 11 is a block diagram of an example computing environment suitable for use in implementing aspects of the technology described herein.

### DETAILED DESCRIPTION

The technology described herein is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

To obtain particular information about an item of interest, an individual may initiate various searches on the computer to locate the item or information about the item. For example, a user may initiate a web search, an email search, a document search, a calendar search, or the like, to identify desired information. It can be very time consuming, however, to identify the desired item and information about it, particularly when extensive amounts of data exist. Identifying a desired item is even more difficult when context associated with the item is lacking. For example, a user may recall collaborating on a document with two other users, but such recollection may not be helpful in locating the particular document when searching through document titles. Similarly, when the user may not remember nor recognize the particular document that was the subject of the collaboration, when the user comes across that document, such as in a file manager or search result. For instance, the user may be required to conduct a search for documents existing around the time of the collaboration and then open up multiple documents in order to find the one that was the subject of a collaboration. Or similarly, the user may be required to navigate a record of email messages with attached documents in order to identify the particular document that was a subject of collaboration.

Various technologies have been developed in an effort to facilitate surfacing relevant information for a user. For example, a data feed service (e.g., Microsoft® My feed) can provide a combination of content (e.g., from across applications) based on what is likely to be most relevant to the particular user at the particular time. Generally, a data feed service may include content that has been shared with the user or content to which the user has access. For example, a data feed service may present a user with various documents, emails, upcoming meetings, or the like, that are deemed relevant to the user. In some cases, a data feed presents the various content using cards. A card generally refers to a user-interface container for related information. Presenting various content, via a card in a data feed, can surface relevant or desired information for a user. However, a card lacking context is oftentimes unappreciated or overlooked by a user. For example, a card may include a link to a particular document, but without context associated with the document, the user may not recognize that document or may not appreciate the value or present status associated with the document. Consider for instance, a card presented to a user, which indicates a particular document has been updated. This particular card lacks any context about the document. Unless the user remembers the relevance or context of that document, the user may overlook this card; it may not be particularly helpful for the user. Moreover, this card lacking context could result in the user unnecessarily opening the document to view the document and understand whether it is of interest to the user at that time. Now consider for instance, the card indicates that the particular document has been updated since the user last accessed it and/or the card indicates that the updated document is relevant to the user's work on a specific project. This insight about the document is more useful to the user; the card is less likely to be overlooked or dismissed because the user is provided additional insight about the document.

As obtaining desired information may be time-consuming and burdensome, particularly when multiple search iterations and/or item accesses are performed to locate relevant information, computing and network resources are unnecessarily consumed to facilitate the searches and item accesses. For instance, computer input/output (I/O) operations are unnecessarily multiplied in an effort to identify a relevant item, such as a document or electronic communication. As one example, each time a query for a document is initiated, the information must be searched for and located at a particular computer storage address of a storage device. The searching and locating of the relevant information is computationally expensive and increases latency. For instance, assume the requested data is located in a disk array. In such a case, the read/write head of the disk manually locates the correct disk and address. When such queries are repetitively issued, as is the case with these existing technologies, there is unnecessary wear placed on the read/write head as well as increased computer latency because of the number of times the disk is accessed via the read/write head. Similarly, such queries repeatedly issued against solid state storage will consume the limited program/erase cycles of the storage, thereby increasing the likelihood of failure sooner than would otherwise occur. Further, when databases are accessed, processing queries consumes many computing resources, thereby decreasing throughput and increasing network latency. As such, the use of computer and network resources is increased due to the unnecessary quantity of queries executed and/or item accesses.

Additionally, such repetitive search operations can often result in packet generation costs that adversely affect computer network communication. Each time a user issues a query, for example, the contents or payload of the query is typically supplemented with header information or other metadata within a packet in TCP/IP and other protocol networks. Accordingly, when the number of queries increases to obtain desired data, as is the case with the existing technologies, there are throughput and network latency costs by repetitively generating this metadata and sending it over a computer network.

Accordingly, the technology described herein is directed to facilitating the generation, provision, and utilization of item insights in an efficient and effective manner. Advantageously, efficiencies of computing and network resources can be enhanced using implementations described herein. In particular, the item insight generating technology described herein provides for a more efficient use of computing resources (e.g., less packet generation costs and reduced I/O) than conventional methods of searching for items of interest and/or item accesses. For instance, the technology described herein enables a user seeking particular information to identify the item, without requiring the user to access and/or download any additional information or interfaces. In this regard, the user can efficiently and effectively discover contextually relevant information associated with an item and therefore determine relevance of an item, instead of randomly and repeatedly browsing various information looking for the desired information (e.g., opening and viewing various documents), thereby resulting in unnecessary computing resources used to process multiple scroll inputs and/or multiple screen rendering updates.

Also advantageously, some implementations of the technology described herein improve the operation of computing systems by enabling new functions. In particular, an item insight can be used as metadata by a computing system to provide new ways of processing and managing particular data. Further, an item insight can be used as metadata to provide new functions and features of computer applications and services, such as file explorer, search, and communications.

Computationally, the technology described herein results in less I/O and, thus, less wear and tear on a read/write head, as well as reduced latency as the user does not have to access and/or download items to view in an effort to locate a desired item. There are also reduced network latency costs because fewer packets are being populated and sent over a computer network. Further, because less queries are issued to identify desired information, there are less query execution costs. As such, implementations described herein can conserve network resources and input/output operations of the user device, a data feed service, a document service, a communication service, etc.

In operation, to facilitate generating and/or providing item insights in an efficient and effective manner, aspects described herein include an item insight service. Item insights generally refer to insights or information related to an item. Without limitation, an item may be a document, a file, a calendar event, a website, or an electronic communication (e.g., an email, a text message, an instant message, an online chat, a video message, an audio message, comment, post, or other electronic communication). One example of an item insight described herein is a collaboration network insight. A collaboration network is generally used to refer to a set of individuals or entities and items (e.g., documents, files, calendar events, electronic communications, etc.) that are relevant to a user in regards to a particular context or endeavor. For example, content created or communicated that is associated with a particular project may fall within a particular collaboration network. Thus, a collaboration network insight refers to an indication of a collaboration network (or aspects of a collaboration network) associated with an item. In some instances, a collaboration network insight is provided in relation to an item as a collaboration network indicator. For instance, in the example of a card described previously, some embodiments of the card comprise a collaboration network indicator that provides information about a collaboration network associated with a document that is the subject of the card. A collaboration network may be indicated or identified in any number of ways, such as via a collaboration network identifier (e.g., name), an indication of other individuals associated with the collaboration network (e.g., content or item creators or contributors).

Another example of an item insight described herein is an item context insight. An item context insight refers to an indication of context associated with an item. In some instances, item context insight is provided in relation to an item as an item context indicator. For instance, in the example of a card described previously, some embodiments of the card comprise an item context indicator that provides information about a context of a document that is the subject of the card, such as that the document has been updated since the user last accessed it. By way of example and without limitation, an item context can indicate a status or state of the item, updates or modifications associated with the item, an individual(s), or number of individuals associated with an update or modification of the item, or another context about the item.

In accordance with generating item insights, such as collaboration network insights and/or item context insights, such insights can be provided, as indicators, to the user device for display to the user. In some implementations, the insights are presented via a card, for example presented in a data feed. For example, a card presented in a data feed to surface a document may include a collaboration network indicator indicating a collaboration network associated with the document (or an aspect of the collaboration network, such as other individuals who have contributed to the document). In addition or alternatively, a card presented in a data feed to surface a document may include an item context indicator indicating a context associated with the document, such as information indicating that an individuals has contributed to the document since the user last viewed the document. The card may be provided for display in any number of formats. For example, the card may include an indication of an item (e.g., a link to a document) as well as context associated therewith, such as collaboration network indicator and/or item context indicator, among other things. Such item insights, including a corresponding collaboration network indicator and/or item context indicator, provides the user with information to understand the relevance of the particular item. As described herein, item insights may be additionally or alternatively provided in other contexts, such as a file explorer, search application, messaging application, a calendar application, a document application, email application, or other computer application.

Advantageously, the new computing functionality enabled by the item insights improves the operation of computer systems by providing new ways to process and manage particular data, as well as new functions of computer applications. Moreover, providing the item insights in an efficient manner enables a user to have a more clear view into the context of an item indicated in the user interface (e.g., via a data feed) without having to manually track down the desired data using various systems and queries thereto. An efficient and effective manner of providing insights related to an item (e.g., within the context of data feed, a document service, an electronic communication service, a web search service, etc.) generates a more user-friendly experience. In particular, a user is not required to manually search for desired information via other resources or unnecessarily open and view items, thereby resulting in less utilization of computing device resources.

### Overview of Example Environments for Facilitating Generation of Item Insights

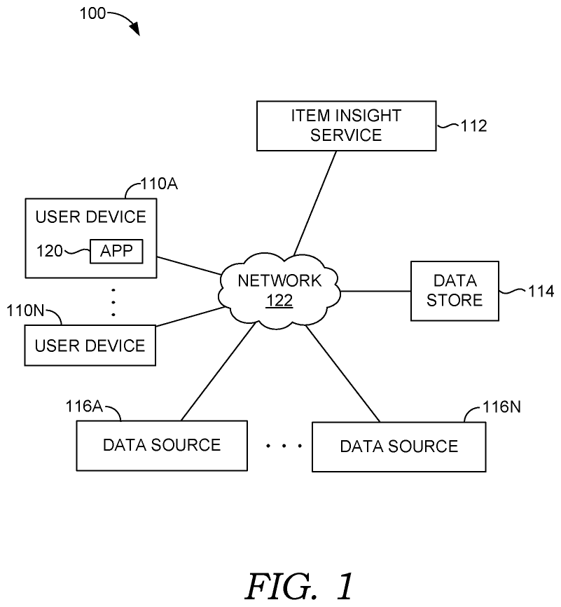

Referring initially to FIG. 1, a block diagram of an example operating environment 100 suitable for use in implementing embodiments described herein is shown. Generally, the example operating environment 100 illustrates an environment suitable for facilitating implementation of technology for item insights. Among other things, embodiments described herein efficiently and effectively generate and provide item insights, such as collaboration network insights and/or item context insights. Generally, a collaboration network insight refers to an insight, data, or information related to a collaboration network. In some cases, as described herein, a collaboration network insight provides an indication of a collaboration network associated with an item. Stated differently, a collaboration network insight can provide an indication of a collaboration network to which the item belongs or is associated, and may be provided as a collaboration network indicator. As described previously, a collaboration network is generally used to refer to a set of individuals or entities and items (e.g., documents, files, calendar events, electronic communications, etc.) that are relevant to a user in regards to a particular context or endeavor. Accordingly, a collaboration network may include both the individuals/entities and items created by, modified by, accessed by, viewed by, or otherwise having an association to such individuals/entities in the collaboration network.

An item context insight provides context associated with an item, for example, related to a status, state, or modification of the item and may be provided as an item context indicator. In some cases, the item context insight provides context of the item relative to the user. For instance, the item context insight may indicate one or a number of modifications made to a document since the user last viewed the document. Advantageously, providing the item insights in an efficient manner enables a user to have a clearer context of an item without having to manually perform operations to determine the context, such as accessing and using various applications, system services, and/or queries thereto.

The operating environment 100 includes a user device 110a-110n (referred to generally as user device(s) 110), an item insight service 112, a data store 114, and data sources 116A-116N (referred to generally as data source(s) 116). The user devices 110A-110N, the item insight service 112, the data store 114, and the data sources 116A-116N can communicate through a network 122, which may include any number of networks such as, for example, a local area network (LAN), a wide area network (WAN), the Internet, a cellular network, a peer-to-peer (P2P) network, a mobile network, or a combination of networks.

The operating environment 100 shown in FIG. 1 is an example of one suitable network environment and is not intended to suggest any limitation as to the scope of use or functionality of embodiments disclosed throughout this document. Neither should the example operating environment 100 be interpreted as having any dependency or requirement related to any single component or combination of components illustrated therein. For example, the user devices 110A-110N and data sources 116A-116N may be in communication with the item insight service 112 via a mobile network or the Internet, and the item insight service 112 may be in communication with data store 114 via a local area network. Further, although the operating environment 100 is illustrated with a network, one or more of the components may directly communicate with one another, for example, via HDMI (high-definition multimedia interface), and DVI (digital visual interface). Alternatively, one or more components may be integrated with one another, for example, at least a portion of the item insight service 112 and/or data store 114 may be integrated with the user device 110 and/or data sources 116. For instance, a portion of the item insight service 112 may be integrated with a server (e.g., of a data feed service) in communication with a user device, while another portion of the item insight service 112 may be integrated with the user device (e.g., via application 120).

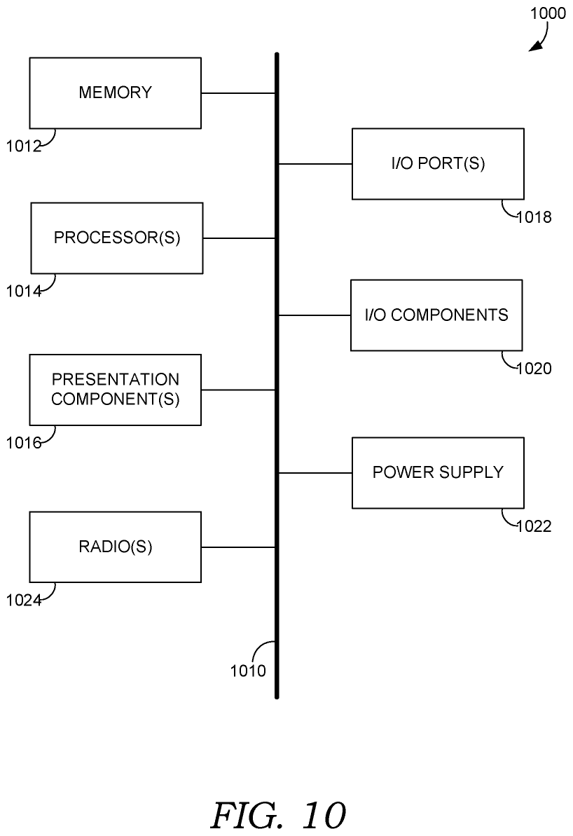

The user device 110 can be any kind of computing device capable of facilitating determining and/or providing item insights. For example, in an embodiment, the user device 110 can be a computing device such as computing device 1000, as described above with reference to FIG. 10. In embodiments, the user device 110 can be a personal computer (PC), a laptop computer, a workstation, a mobile computing device, a PDA, a cell phone, or the like.

The user device can include one or more processors, and one or more computer-readable media. The computer-readable media may include computer-readable instructions executable by the one or more processors. The instructions may be embodied by one or more applications, such as application 120 shown in FIG. 1. The application(s) may generally be any application capable of facilitating determining and/or providing item insight data. In some implementations, the application(s) comprises a web application, which can run in a web browser, and could be hosted at least partially server-side (e.g., via a data feed service, such as Microsoft® My feed). In addition, or instead, the application(s) can comprise a dedicated application. In some cases, the application is integrated into the operating system (e.g., as a service). As one specific example application, application 120 may be a tool that provides information associated with items, such as emails, instant messages, documents, etc.

User device 110 can be a client device on a client-side of operating environment 100, while item insight service 112 and data sources 116 can be on a server-side of operating environment 100. Item insight service 112 and/or data sources 116 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110, item insight service 112, and/or data sources 116 to remain as separate entities.

In an embodiment, the user device 110 is separate and distinct from the item insight service 112, the data store 114, and the data sources 116 illustrated in FIG. 1. In another embodiment, the user device 110 is integrated with one or more illustrated components. For instance, the user device 110 may incorporate functionality described in relation to the item insight service 112. For clarity of explanation, embodiments are described herein in which the user device 110, the item insight service 112, the data store 114, and the data sources 116 are separate, while understanding that this may not be the case in various configurations contemplated.

As described, a user device, such as user device 110, can facilitate determining and/or providing item insights, such as collaboration network insights and/or item context insights. A user device 110, as described herein, is generally operated by an individual or entity associated with an item(s). In some cases, such an individual may be a contributor or creator of the item. In other cases, a user may be a viewer or recipient of an item, or enabled to access such an item. In some implementations, determination or provision of item insights may be initiated at the user device 110. For example, in some cases, a user may select to determine or view an item insight(s) related to an item(s). As another example, a user may initiate an application, such as application 120, or an aspect associated therewith, and based on such an initiation, initiate identification and/or provision of an item insight.

Determining and/or providing item insights may be initiated and/or presented via an application 120 operating on the user device 110. In this regard, the user device 110, via an application 120, might allow a user to initiate a determination or presentation of an item insight. Application 120 may comprise any type of computer application, such as a stand-alone application, a mobile application, a web application, a distributed application, a program or routine that is part of another application, or the like. In some cases, the functionality described herein may be integrated directly with an application or may be an add-on, or plug-in, to an application. One example of an application that may be used to initiate and/or present item insights corresponds with a data feed service (e.g., Microsoft® My feed). Another example of an application that may be used to initiate and/or present item insights is a communication service, such as an email service, an instant messaging service, a video messaging service, etc. Yet another example of an application that may be used to initiate and/or present item insights is a document service, such as a document manager, file manager, word processor, etc.

Such determination and/or provision of item insights may be initiated at the user device 110 in various manners. For instance, upon accessing a particular application, a user may be presented with, or navigate to, options associated with item insights. As one example, a user may utilize the user device 110 to access a data feed. In association with an item in the data feed, a user may select to view item insights. For instance, a user may right click or hover over a portion of the data feed (e.g., a card) and be presented with an option to view one or more item insights. In some cases, the user may select to view an item insight corresponding with an item. For example, a user may hover over an indication of an item (e.g., via a card), resulting in an item insight being presented in association with the item (e.g., via the card or as a popup). In other cases, determining and/or providing an item insight may be automatically performed based on other interactions. For example, in accordance with opening an application, or having an application in an active window, determining and/or providing an item insight may be automatically triggered.

As described herein, an item insight may be presented to a user in the any number of formats, such as a card, popup, indication within a file manager, indication within another application such as an email application, or other format. Moreover, an item insight may be in any form, such as a text, an icon, an image, etc. Further, as described herein, an item insight may include any type of information regarding an item. For instance, the item insight may include an email address or name of an individual included in a collaboration network associated with an item. In some cases, an item insight indicator may be presented to indicate that an item insight exists for an item. In such a case, selecting the item insight indicator, or portion thereof, can result in an item insight being presented via a display screen of the user device 110.

The user device 110 can communicate with the item insight service 112 to initiate determination of item insights and/or obtain item insights. In embodiments, for example, a user may utilize the user device 110 to initiate a determination of item insights via the network 122. For instance, in some embodiments, the network 122 might be the Internet, and the user device 110 interacts with the item insight service 112 (e.g., directly or via another service, such as a data feed service, communication service, and/or document service) to initiate generation of item insights. In other embodiments, for example, the network 122 might be an enterprise network associated with an organization. It should be apparent to those having skill in the relevant arts that any number of other implementation scenarios may be possible as well.

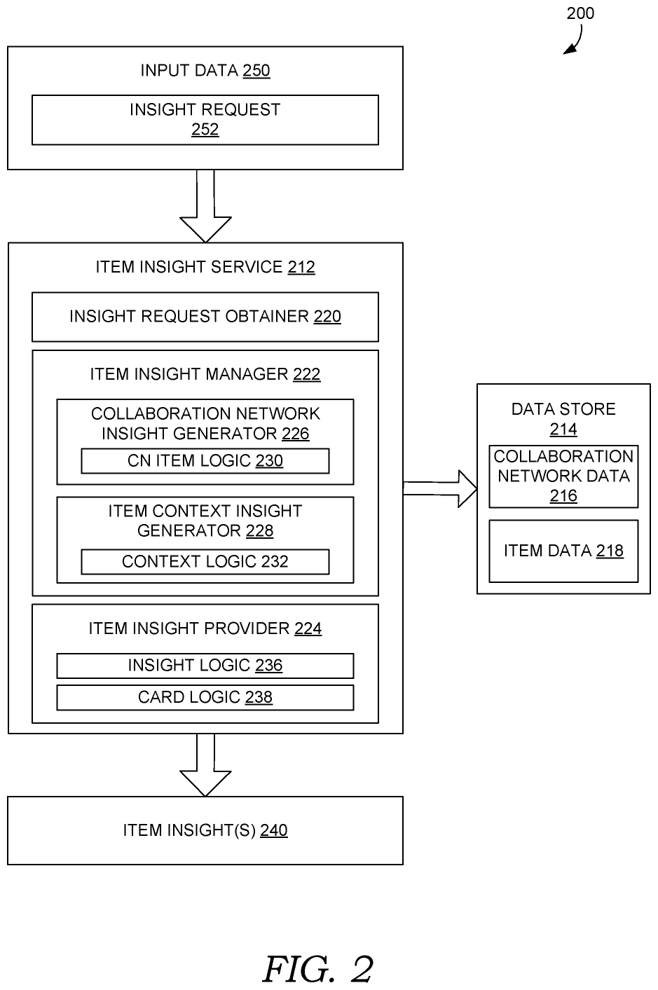

Continuing with FIG. 1, example operating environment 100 includes item insight service 112. At a high level, the item insight service 112 manages determining and providing item insights, such as collaboration network insights and/or item context insights described herein. In particular, the item insight service 112 can receive insight requests. An insight request generally indicates a request for one or more item insights. One example of such an insight request is insight request 252 describes in FIG. 2. In particular, item insight service 112 may be called or invoked by an application 120 or another computer service operating in conjunction with a user device 110A. Accordingly, when an item (e.g. a document) is identified and a corresponding item insight for the item is requested, insight service 112 is called to determine and provide the item insight. As described in connection with insight request 252, in some cases, a user device may provide an insight request. In other cases, another computer application or service, such as a data feed service, communication service, and/or document service may provide an insight request. Insight requests, for example, received from a device, such as user device 110, can include an indication of an item for which an item insight is desired. By way of example only, an insight request may include an item identifier indicating a particular item, such as a document or an electronic communication, for which an item insight is desired. The item insight service 112 can receive insight requests from any number of devices, such as from the user device on which item insight is to be presented. Based on an insight request, the item insight service 112 can determine item insights, for example, using data sources 116. Data sources 116A-116N may be any type of source containing data. For example, data sources may be associated with collaboration network data, item data, etc. In various embodiments, item insight service 112 can be implemented as one or more servers, program modules or functions, virtual machines, or other computer system, or a components of such a system.

In accordance with receiving an insight request(s) (e.g., via the user device 110 or other service), the item insight service 112 can determine one or more item insights. In this regard, the item insight service 112 can determine collaboration network insights and/or item content insights, depending on the implementation. To determine such insights, in some embodiments, the item insight service 112 communicates with a data source(s), such as data source 116. Although illustrated as separate data sources, the data sources can be part of the item insight service. Further any number of data sources may be used. Data source 116 may additionally or alternatively be external or third-party services, servers, data stores, or other components having data. Data sources 116A-116N may be any type of source containing data. For example, data sources may be associated with collaboration network data, item data, etc. As one example, one data source may include collaboration network data, another data source may include document data, another data source may include email data, and still another data source may include instant messaging data, and so forth. Generally, the item insight service 112 can determine item insights using any number of devices. As such, the item insight service 112 can determine item insights using various sources, such as data sources 116A-116N and data store 114. In this regard, the item insight service 112 can retrieve or receive data collected or identified at various components, or sensors associated therewith.

In accordance with determining item insights, such insights can be provided for example, to user device 110 for display to a user (e.g., via application 120). The item insights may be provided in any number of ways. In some embodiments, an item insight(s) is provided in association with a card. As can be appreciated, a card may present other information such as information associated with an item. Item insights can alternatively or additionally be presented in association with a communication interface, a search interface, a document interface, etc. The user device 110 can present received data or information in any number of ways, and is not intended to be limited herein.

In other cases, such item insights may be provided to another component or service, such as a data feed service, a communication service, a document service, a search service, etc., for using or providing the item insights to the user device 110. Such a service may be any type of server or service that can facilitate providing items. In this way, such a service may communicate with application 120 operating on user device 110 to provide back-end services to application 120. Although such a service is not shown, the service can be separate from the item insight service 112 or can be integrated with such a service. For example, an item insight service may be incorporated into or in communication with a data feed service, a communication service, a document service, and/or the like.

Advantageously, utilizing implementations described herein enable generation of item insights to be performed in an efficient manner. Further, the generated item insights can dynamically adapt to align with information determined as desired by the user and/or in real-time to the user. As such, a user can view desired and up-to-date information and can seamlessly assess the information.

Turning now to FIG. 2, FIG. 2 illustrates an example computer implementation 200 for providing item insights, via item insight service 212. As shown in this example implementation 200, item insight service 212 communicates with the data store 214. The data store 214 is configured to store various types of information accessible by the item insight service 212. In some embodiments, item insight service 212 is implemented as an item insight service 112, described in FIG. 1. Similarly, in some embodiments, data sources (such as data sources 116 of FIG. 1), user devices (such as user devices 110 of FIG. 1), and/or item insight service 212 can provide data to data store 214 for storage, which may be retrieved or referenced by item insight service 212 or by another component. As such, the data store 214 can store collaboration network data 216, item data 218, and/or other information regarding a content item.

In operation, the item insight service 212 is generally configured to manage determination and/or provision of item insights. In this example implementation of FIG. 2, the item insight service 212 includes an insight request obtainer 220, an item insight manager 222, and an item insight provider 224. According to embodiments described herein, the item insight service 212 can further include any number of other components not illustrated in this example implementation. In some embodiments, one or more of the illustrated components 220, 222, and 224 are integrated into a single component or are distributed into a number of different components. Further, components 220, 222, and 224 can be implemented on any number of machines and can be integrated, as desired, with any number of other functionalities or services.

Insight request obtainer 220 is generally responsible for receiving or obtaining item insight requests or input to initiate the generation (or provision) of an item insight. In particular, insight request obtainer 220 receives or obtains input data 250, which may include an insight request 252. In some embodiments, input data 250 may comprise information related to an insight request 252 such as attributes associated with an item indicated in the insight request 252. Such input data 250 can be received from any number of devices or components, including other computer applications (e.g., application 120 of FIG. 1) or computer services, that operate on a computer system, such as user device 110A of FIG. 1. For example, an insight request 252 may be received user device 110N of FIG. 1, to which to provide item insights.

As described herein, an insight request generally refers to a request to provide an insight regarding a particular item, and may comprise a computer instruction (e.g. a function call) requesting the insight about the particular item. Alternatively, an insight request may be received as an indication of a particular item for which an item insight is to be determined, such as a reference to a document or a file uniform resource indicator (URI). Particular items of an insight request for which to determine an item insight may be determined in any number of ways. In some implementations, an insight request is received from a computer application or service that is handling a content item for which the item insight corresponds. For example, a data feed application communicates an insight request 252 for a particular content item to be presented within a card of the data feed. For instance, for a card about a content item that is a document, the data feed application (or a computer service associated with the data feed application) issues an insight request 252 to item insight service 212 that identifies the particular document. In this way, insight service 212 receives the request that indicates the particular document and can facilitate generating or providing an item insight about the document, such as a collaboration network insight and/or an item context insight, as described herein. In another example, a search application or service communicates to insight service 212, an insight request 252 regarding a particular content item that is in the search results, such as a particular file indicated in the search results. In this way, insight service 212 receives the request that indicates the particular file and can facilitate generating or providing an item insight about the file, such as a collaboration network indicator and/or an item context indicator, as described herein, thereby enabling the search application to present corresponding item insights for the items presented in the search results. In yet another example, an email application communicates to insight service 212 an insight request 252 regarding a particular content item that is an attachment in the email. In this way, insight service 212 receives the request that indicates the particular item and can facilitate generating or providing an item insight about the attachment, such as a collaboration network indicator and/or an item context indicator, as described herein, thereby enabling the email application to present corresponding item insights for the attachment. In some embodiments, an insight request 252 is provided to item insight service 212 automatically.

In some cases, an insight 252 request is provided based on activity by the user via a user device, such as user selection of an item (e.g. a file) indicating a desire by the user to be presented with an insight about the item. For example, a user may interact with a file (e.g., right click on or hover over a file) to view an item insight, which may be provided via a pop-up menu or window. Similarly, a user accessing a data feed or a particular card in a data feed can cause a computer service associated with the data feed to send or trigger an insight request 252. In some cases, an insight request 252 is provided based on a configuration (e.g. a user or administrator setting) of an application or service operating on a user device. For instance, a file manager application may be configured for an option to view item insights corresponding to files that are presented within the file manager application. Similarly, other computer applications or services may be configured for viewing (or a user may select an option to view) one or more item insights via a graphical user interface.

In yet other examples, an insight request 252 is provided based on a determination by a computer application or computer service that a particular item is of interest to a user, and/or that a particular item, which may be of interest to a user, has changed its status (e.g. it has been accessed or modified). As one example, an item(s) of interest may be determined based on a date/time associated with an item. For instance, any items with a status or state change (within a threshold time) are be identified. By way of example only, any documents generated or modified within the past week may be identified as items of interest. Similarly, any documents that a user has previously accessed and that have been modified or accessed by another person within the past week may be identified as items of interest. As still another example, an item with any modification may be identified (e.g., a modification within a threshold time, such as the past week; a number of modifications, such as more than one modification; modifications by more than one individual or entity; etc.). A status change, state change, and/or modification may be used herein to refer to any alterations associated with an item, such as, for example, an edit to the item, a comment associated with the item, a response associated with the item, a view associated with the item, etc. A change in state, status, or other modification can be identified in any number of ways, such as by accessing a data source (e.g., data source 116 of FIG. 1) containing such information about an item. For instance, in one embodiment, metadata associated with an item includes modification date information. In some embodiments where an item insight service 212 receives multiple requests for determine an item insight for items of interest (in particular where the items of interest are related), insight service 212 may rank or prioritize the items for which to determine an item insight. For example, insight requests 212 may be ranked or prioritized based on the particular items to which they indicate, such as based on the number of modifications to the item, recency or freshness of the modifications, items deemed or determined most important to the user, items explicitly selected by the user (such as via GUI, dashboard, file manager, right-clicking on the item, or the like) as items for which the user desires to be provided item insights.

In some implementations, an insight request 212 also includes (or may be used to determine) attributes regarding the item that are usable to facilitate determining the item insight. Examples of item attributes include various metadata associated with the item such as an indication of the item type (e.g., a document, an email, an instant message, etc.), an item identifier (e.g., an identifier of a document, an email, an instant message, etc.), a time/date associated with the item or associated with the insight request, a creation or modification date of the item, an access log or a change-log associated with the item, or other metadata regarding the item. For example, in one implementation in which a user seeks information associated with a particular item such as a document, an item identifier (such as a file URI for the document) is provided along with the insight request 252.

Continuing with example computer implementation 200, item insight manager 222 is generally responsible for managing the determination of one or more item insights based on a received insight request 252. In this example implementation, item insight manager 222 includes a collaboration network insight generator 226 and an item context insight generator 228. As can be appreciated, any number of components may be used to provide functionality of the item insight manager 222. For example, in some cases, a single component may perform the functionality described in relation to the collaboration network insight generator 226 and the item context insight generator 228. Further, item insight manager 222 may generate additional insights, and is not limited to generating collaboration network insights and/or item context insights. Although generation of both collaboration network insights and item context insights is described herein, as can be appreciated, in some implementations, only one type of insights may be generated.

In some embodiments multiple item insights may be determined for a particular item, and item insight manager 222 determines which specific item insights to provide for a particular item. (Alternatively, in some embodiments, this function is performed by item insight provider 224 using insight logic 236, as further described herein.) For example, in some instances, particular item insights (or types of item insights, such as collaboration network insights and item context insights are scored or weighted, and the score (or weighting) used for ranking the item insights or for applying a threshold, such that the highest ranking item insights or item insights satisfying the threshold are provided. In an embodiment, the item insights are scored (or weighted) based on relevance to the user. Alternatively or in addition, item insights are scored (or weighted) based on a time-related aspect, such as recency of an event associated with the item (e.g., recency of a modification to a file), or that a certain amount of time has lapsed and a user has not performed an action (e.g., a user has not responded to a particular email). In some embodiments user feedback may be used to weight particular item insight types so that item insights are more likely to be provided, if they are determined for an item. Still further, in some embodiments information regarding the computer service or computer application that issues the insight request 252 is used to score (or weight) an item insight. For example, it is contemplated that certain item insights may be more useful in certain applications; for instance, for an item insight about a document shared via meeting application during a meeting, it may be helpful to know that the document has not been viewed by all of the meeting participants. Accordingly, the particular computer application or service that issues the insight request 252 (or other aspects of the insight request 252) may be used by item insight manager 222 to determine a particular item insight to be provide for an item.

The collaboration network insight generator 226 is generally responsible for determining collaboration network insights. A collaboration network insight generally refers to information indicating a collaboration network (or an aspect of a collaboration network) relevant or related to an item. As described herein, a collaboration network refers to a set of items (e.g., documents, files, calendar events, electronic communications, comments, and other items of content) and individuals or entities that are relevant to a user in regards to a particular context or endeavor. For example, the individuals or entities (e.g., groups, organizations, teams, offices, venues, etc.) of a collaboration network would comprise individuals collaborating in association with the items by way of creating items, modifying items, viewing items, accessing items, etc. Accordingly, for a particular item, the collaboration network insight generator 226 identifies which collaboration network the item is associated. By way of example, assume a particular document is selected. In such a case, the collaboration network insight generator 226 can identify the collaboration network associated with the particular document, which would include, for instance, a group of people who have modified the document. Particular collaboration network insights determined by collaboration network insight generator 226 may be provided by an item insight provider 224 as item insights 240.

In some embodiments, to identify a particular collaboration network associated with a particular item, the collaboration network insight generator 226 utilizes or references collaboration network data. In this regard, collaboration network data previously generated may be accessed to identify a particular collaboration network associated with an item. In one example, the collaboration network insight generator 226 accesses collaboration network data 216 in data store 214, to identify the collaboration network associated with an item. In one example, item attributes, such as an item identifier, or other information about the item included in the insight request 212 (or determined from the insight request 212) is be used to lookup or reference (via collaboration network data 216) a collaboration network to which the item belongs.

In some embodiments, any content created or communicated that is association with a particular project or endeavor is part of a particular collaboration network. Thus collaboration network data 216 includes any data associated with the collaboration network, such as, for example, user identifiers indicating users associated with the collaboration network, item identifiers indicating items in the collaboration network, items or data, or metadata, associated therewith, etc. In some implementations, collaboration network data 216 includes various collaboration networks or indications of various collaboration networks.

Collaboration networks may be data generated and stored in any number of ways. U.S. application Ser. No. 17/363,977, titled “Structuring Communication and Content for Detected Activity Areas,” which is incorporated by reference, provides example implementations for generating collaboration networks. In one embodiment, a user's items, or activities associated therewith (e.g., receiving, accessing, sending, creating, modifying, deleting, viewing, attending, organizing, setting, monitoring, etc.), the people associated with the items, and the content associated with the activities are automatically inferred or detected based on the channels of collaboration associated with the activities, such as electronic mail, instant messages, documents, meetings, and the like. For instance, artificial intelligence or one or more machine learning mechanisms (e.g., models, algorithms, or applications) are used to infer the user's items, the people associated with the items, and the content associated with the items. Some or all of this data is analyzed to determine one or more collaboration networks the user has focused on over a period of time. Such collaboration networks can be determined or updated in real-time, in substantially real-time, at predefined interfaces (e.g., once a week), or on demand. As such, as activities, people, and content the user focuses on change over time, the collaboration networks change as well.

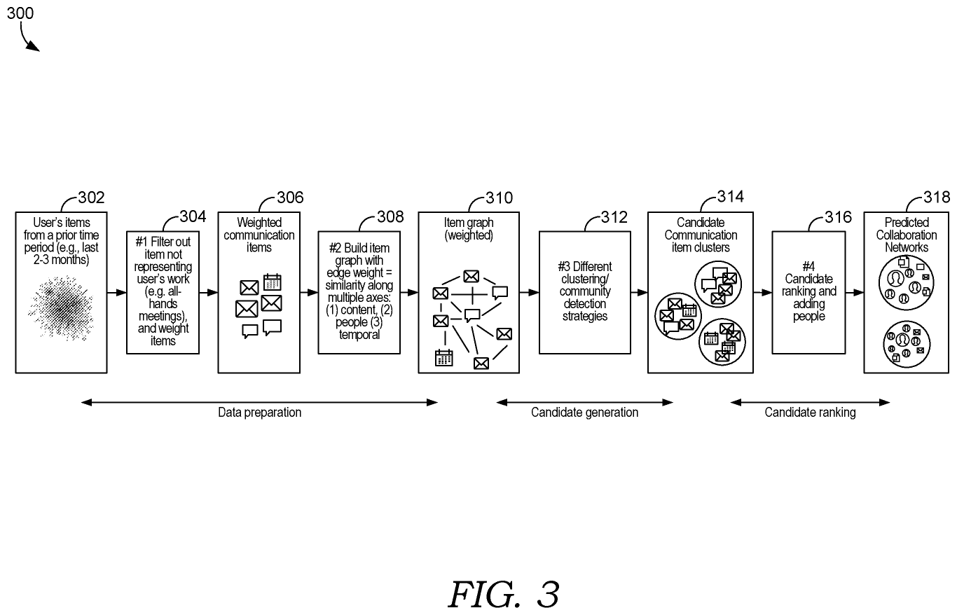

With reference to FIG. 3, one example implementation 300 for determining or inferring collaboration networks is illustratively provided. Initially, items associated with a user from a prior time period are collected, as shown at 302. For example, items, such as communication items, associated with a user can be collected from the last two to three months. At 304, items identified as not representing the user's work are removed or filtered from the collected items, and the remaining items are weighted. For instance, items associated with meetings that do not represent the user's work can be filtered from the collected item. The remaining items can then be weighted, as illustrated at 306. At block 308, an item graph is generated. In embodiments, the item graph includes an edge weight approximately equal to similarity along multiple axes, such as content, people, and temporal. For instance, in FIG. 3, item graph 310 is generated. At 312, different clustering and/or communication detection strategies are applied. As such, candidate item clusters, such as communication item clusters, are created, as shown at 314. Thereafter, at 316, candidate ranking is performed along with identifying entities or individuals associated with such item clusters. In this manner, predicted collaboration networks are generated, as shown at 318. As can be appreciated, various technologies may be used to perform such a process. For instance, unsupervised clustering algorithms may be used. As one example, an unsupervised cluster algorithm with hyperparameter tuning from ground truths may be used. Using such an approach, evaluation may be performed based on manually constructed ground truth collaboration networks. In other implementations, embeddings associated with 308 and 312 may be leveraged and/or supervised methods may be used.

Returning to FIG. 2 and example computer implementation 200, in some cases, the collaboration network insight generator 226 recognizes an item for which to generate a collaboration network insight based on an indication of the item associated therewith. For example, in cases in which an insight request 252 indicates an item, the collaboration network insight generator 226 identifies the item indicated via the insight request 252 for which to generate or provide a collaboration network insight. In this regard, some embodiments of collaboration network insight generator 226 access collaboration network data 216 and identify a collaboration network to which the item belongs based on an indication of the item determined from insight request 252.

In some implementations, the collaboration network insight generator 226 uses collaboration network (CN) item logic 230 to identify a collaboration network for an item. Embodiments of CN item logic 230 can include rules, conditions, associations, classification models, and/or computer instructions, to facilitate the identification of (or inference of) a collaboration network associated with an item. CN item logic 230 may take different forms depending on the mechanism used to determine items of interest. For example, CN item logic 230 may comprise a statistical model, fuzzy logic, neural network, finite state machine, support vector machine, logistic regression, clustering, or machine-learning techniques, similar statistical classification processes, or combinations of these to identify or infer a particular collaboration network for an item of interest. Further, in some embodiments, potential corresponding collaboration networks determined by collaboration network insight generator 226 using CN item logic 230 may be scored and ranked based on having the highest probability of correspondence, so that the highest scoring collaboration network is provided as the likely corresponding collaboration network.

The CN item logic 230 of the collaboration network insight generator 226 may determine which data to analyze (e.g., data associated with a particular item type, such as documents, etc.), an extent of data to analyze (e.g., data associated with items created or modified in a particular time frame), etc. In some cases, data to analyze and/or an extent of data to analyze may be based on user preferences, default settings, logic, etc. For example, in cases that a user corresponds with an extensive amount of collaboration networks, a different extent of data may be analyzed than a user that corresponds with a lesser amount of collaboration networks. As such, the CN item logic 230 may be configured for customization with a particular user or aspects associated with a particular user. In some cases, CN item logic 230 ranks or prioritizes the items of interest, for example, based on number of modifications, recency or freshness of modifications, items deemed or determined most important to the user, etc. Similarly, in some cases, CN item logic 230 includes computer instructions for weighting or scoring collaboration network insights so that item insight service 212 can rank or prioritize particular collaboration network insights to be provided, as described herein.

For each identified item of interest, a corresponding collaboration network may be identified (e.g., by referencing collaboration network data). For example, assume a first document, a second document, and a third document have been identified as items of interest based on changes to a status of such documents within the last week. In such a case, for each of the first document, the second document, and the third document, a collaboration network for each item is identified.

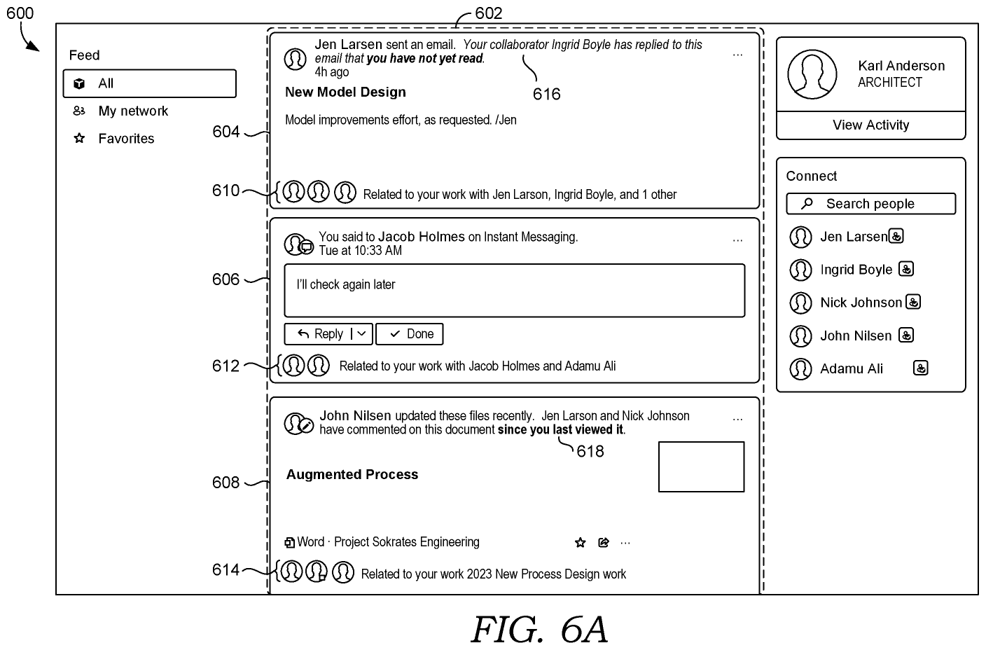

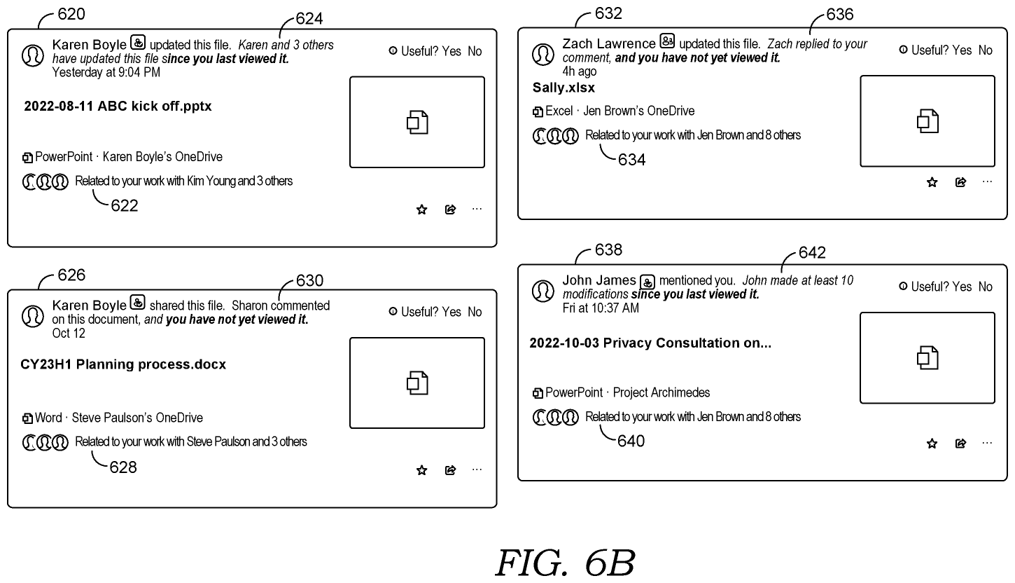

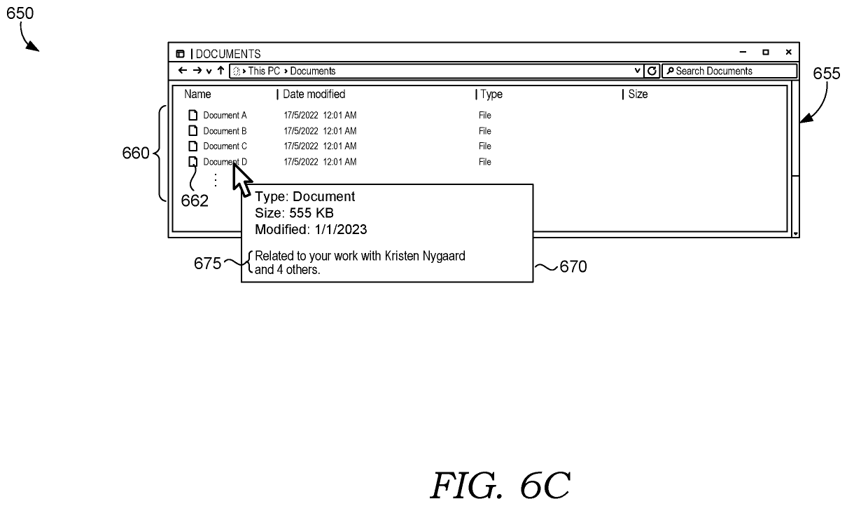

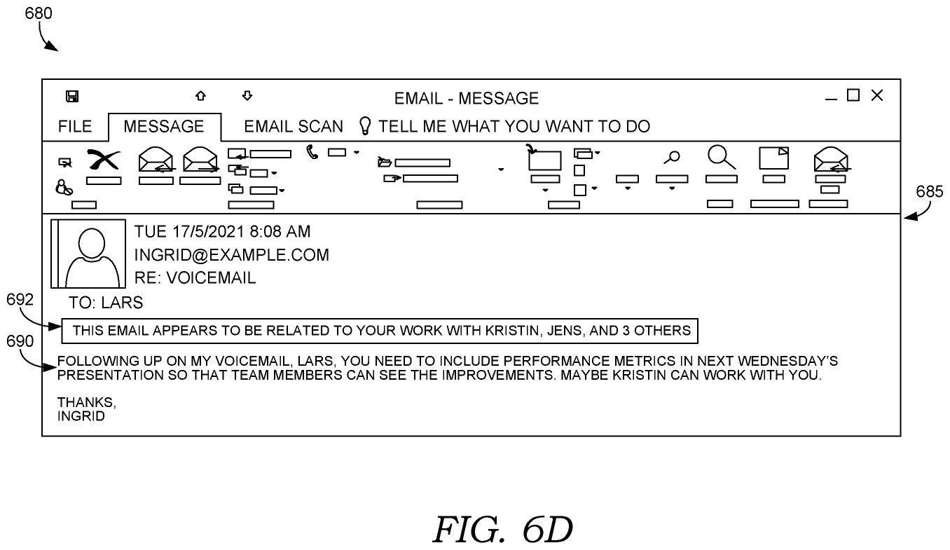

In accordance with identifying a collaboration network for a particular item (or set of items), the collaboration network insight generator 226 generates the collaboration network insight(s). In some instances, the collaboration network insight is stored (e.g., in data store 214) with or associated with the particular item. The generated collaboration network insight may comprise an indication of the collaboration network corresponding to a particular item, such as the name of the collaboration network (or a name of the project or endeavor that is the subject of the collaboration). Additionally or alternatively, the collaboration network insight may comprise an aspect of the collaboration network, such as other subject matter within or associated with the collaboration network. For example, the collaboration network insight may comprise an indication of some of the other individuals in the collaboration network, such as the example item 610 of FIG. 6 (further described in connection with FIG. 6). As another example, the collaboration network insight may comprise an indication of other subject matter related to the collaboration network, such as an indication that a particular item is related to an email that the user received.

Item context insight generator 228 is generally responsible for determining item context insights. In this regard, for a particular item, the item context insight generator 228 identifies a context associated therewith. For example, for a particular item that is a document, item context insight generator 228 determines a context associated with the document, such as that the document was updated since the user last accessed it. By way of example and without limitation, a context insight may indicate a status or state of the item, updates or modifications associated with the item, an individual(s), a number of individuals associated with an update or modification of the item, a user or occurrence of the item, or an event (such as a meeting) associated with the item. In some cases, the item context insight provides context of the item relative to the user. For instance, an item context insight may indicate a user needs to catch up in regards to an activity of others for a particular item or aspect of an item. By way of example only, an item context insight can indicate a user has not performed an action or activity in relation to other individuals in a collaboration network. For instance, the item context insight may indicate a number of modifications made to a document since the user last viewed the document. In this way, the item context insight may indicate an overview of what has happened and what is upcoming for a collaboration. Examples of such item context insights may relate to communications missed by a user (or not yet viewed by a user), activity on important items, upcoming meetings, outstanding tasks, follow-ups, etc. Particular context insights determined by item context insight generator 228 may be provided by an item insight provider 224 as item insights 240.

To identify an item context insight, some embodiments of item context insight generator 228 utilize or reference item data. In this regard, item data previously generated may be accessed to identify a particular context associated with the item. In one example, the item context insight generator 228 may access item data 218, for example in data store 214, to identify item context insights. Item data 218 includes any data associated with an item, such as states of item, modifications to item (e.g., edits, views, accesses, senders, receivers, or other activities associated with an item), content of an item, related items, and/or the like. Item data 218 also include metadata associated with an item, in some embodiments. Item data 218 may be generated and/or stored in any number of ways (e.g., via data stores, data sources, etc.), such as derived from a data source 116A and stored in a data store 214.

In some cases, item context insight generator 228 recognizes an item for which to generate an item context insight based on an indication of the item associated therewith. For example, in cases in which an insight request 252 indicates an item, the item context insight generator 228 identifies the item indicated via the insight request 252 for which to generate or provide an item context insight. In this regard, some embodiments of item context insight generator 228 access item data 218 and identify item context associated with the item based on an indication of the item determined from insight request 252. In some embodiments, particular items for which to generate item context may be based on analysis performed by the collaboration network insight generator 226, or other component of example computer implementation 200. For example, in an embodiment, item context insight generator 228 identifies other items for which a collaboration network is identified (e.g., via collaboration network insight generator 226) and, thereafter, identifies item contexts associated with such items.

Some implementations of the item context insight generator 228 uses logic, such as context logic 232 to facilitate determining a context for a particular item. For example, an embodiment of context logic 232 comprises computer instructions for identifying and analyzing aspects of particular data related with an item to determine a context for the item. By way of example and without limitation, context logic 232 may specify: particular types of data or metadata for processing to determine a context, which may be determined based on the item or an attribute associated with the item (e.g., data associated with a particular item type, such as documents, communications, etc.); sources of the particular data (e.g., communications information, file system information, a collaboration network to which an item belongs, or other data sources); dates and/or times including time spans associated with the item, which may be specific to particular item data types; an extent of data to analyze, which may be specified as a condition (e.g., process all communications sent during a particular time frame; similarly process data associated with items created or modified in a particular time frame); or other aspects of data (including metadata) related to an item or a collaboration network associated with the item. In some implementations, data to analyze and/or an extent of data to analyze (or the other aspects of data) are based on user preferences or administrator settings (which may include organizational settings), or default settings. For example, in situations that a user corresponds with an extensive amount of collaboration networks, a different extent of data may be analyzed than a user that corresponds with a lesser amount of collaboration networks. As such, context logic 232 may be configured for customization with a particular user or aspects associated with a particular user, a particular activity, or a particular organization. In some cases, context logic 232 includes computer instructions for weighting or scoring item context insights so that item insight service 212 can rank or prioritize particular item context insights to be provided, as described herein.

In some embodiments, context logic 232 is used by context insight generator 228 to facilitate identifying or generating a context associated with an item. In this way, for various items, context logic 232 can be utilized by item context insight generator 228 to determine a context associated therewith. Context logic 232 may be applied in association with any number of items. For instance, context logic 232 may be applied to each item associated with a user (e.g., each item identified in a set of collaboration networks). As another example, context logic 232 may be applied to particular identified items of interest.

Some embodiments of context logic 232 include rules, conditions, associations, classification models, and/or other criteria, to determine an item context. Context logic 232 can take different forms depending on the particular mechanism used to determine item context. For example, one embodiment of context logic 232 comprises a statistical model, fuzzy logic, neural network, finite state machine, support vector machine, logistic regression, clustering, or machine-learning techniques, similar statistical classification processes, or combinations of these to determine context associated with an item(s). In one embodiment, context logic 232 includes computer instructions comprising a set of rules or logic. As such, the set of rules or logic may be applied in association with various items (e.g., each item corresponding with a user as identified based on a set of collaboration networks associated with the user). In some cases, the set of rules or logic may include rules or logic to determine that the user has or has not performed an activity in relation to other individuals in a collaboration network.

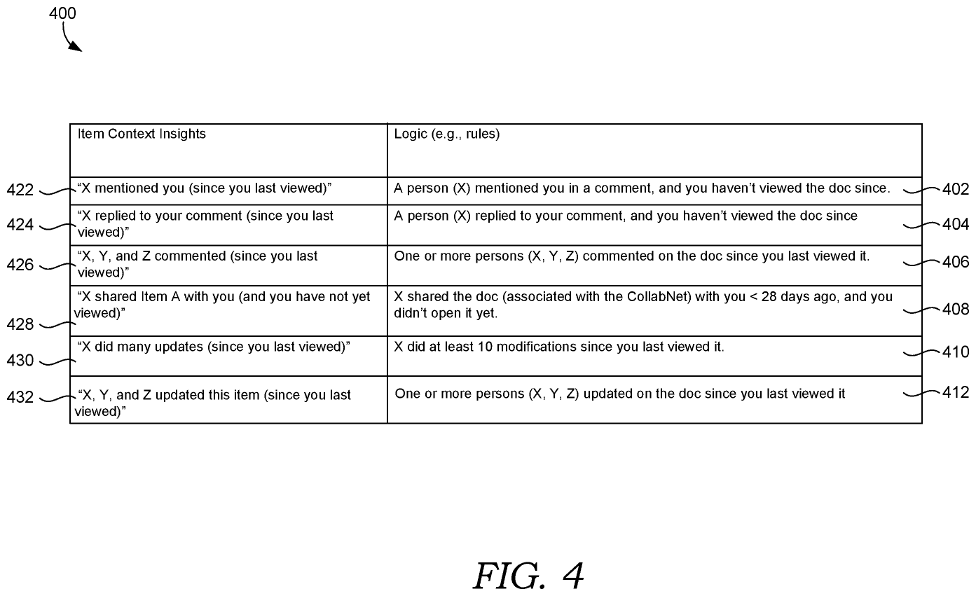

FIG. 4 illustratively depicts a table 400 of aspects of one example implementation of context logic 232 to determine context associated with an item. In this example implementation, the logic depicted in table 400 comprises rules that are applied to a particular item, such as a document. Additionally or in alternative implementations, other forms of logic, such as described in connection with context logic 232, are utilized to determine a particular item context insight for an item. With reference to FIG. 4 and table 400, rule 402 can be used to determine context related to an individual mentioning a user in a comment, and the user has not viewed the document since the mention. Rule 404 can be used to identify context related to an individual replying to a user-provided comment, and the user has not viewed the document since the mention. Rule 406 can be used to identify context related to an individual(s) that commented on an item since the user last viewed the item. Rule 408 can be used to identify context related to an item shared with a user that has not yet been viewed by the user. Rule 410 can be used to identify context related to a number of modifications made in association with an item since last viewed by the user. Rule 412 can be used to identify context related to individuals that updated an item since last viewed by a user. Such rules provided in FIG. 4 are only example rules. As can be appreciated, various rules and other forms of logic can be used to identify context associated with an item or set of items.

Another example of a context item that may be identified using context logic 232 relates to a time estimated for a user to catch up or perform certain actions. For example, based on an amount of time spent by collaborators, an amount of content modified or added by collaborators, historical time spent by the user, etc., context logic 232 includes logic for determining an estimate amount of time the user may be required to spend to perform an action (e.g., read modifications, respond to a comment, etc.) associated with an item.

In accordance with identifying context for a particular item or set of items, the item context insight generator 228 can generate the item context insight. As described, the item context insight generally provides an indication of context associated with the item. For instance, the item context insight may specify that the particular item has been modified since last viewed by the user, has been modified a particular number of times since last viewed by the user, has been modified by a particular set of individuals since last viewed by the user, etc. Generally, the item context insight can provide insight as to why a user may desire to view the item. The item context insight can be in any number of formats, including use of text, icons, images, etc. Returning to FIG. 4, various item context insights are shown. For example, by using rule 402, item context insight 422 can be generated, stating “X mentioned you (since you last viewed).” By using rule 404, item context insight 424 can be generated, stating “X replied to your comment (since you last viewed).” By using rule 406, item context insight 426 can be generated, stating “X, Y, and Z commented (since you last viewed).” Using rule 408, item context insight 428 can be generated, stating “X shared Item A with you (and you have not yet viewed).” Using rule 410, item context insight 430 can be generated stating, “X did many updates (since you last viewed).” This item context insight 430 indicates that a particular amount of updates has been done by a single person. Using rule 412, item context insight 432 can be generated, stating “X, Y, and Z updated this Item (since you last viewed).” Such item context insights can be generated using templates, as one example. In some cases, rules may include a threshold number or amount associated therewith. For instance, a rule may specify to generate an item context insight only if a particular number of modifications has occurred or a particular number of individuals have made modifications, etc. The individuals and/or items indicated in an item context insight can be represented in any of a number of ways. For example, images or icons can be used to represent the individuals. As another example, individual identifiers (e.g., names) can be used to represent the individuals.

Item insight provider 224 is generally responsible for providing item insights 240. In this regard, upon determining item insights, the item insight provider 224 can provide such data for display, for example via a user device. In particular, a collaboration network insight may be provided for display in relation to an item as collaboration network indicator for the item, and an item context insight may be provided for display in relation to an item as an item context indicator for the item. To this end, in cases in which the item insight manager 212 is remote from the user device, the item insight provider 224 may provide an item insight(s) to a user device for display to a user that initiated the request for viewing an item insight(s). Alternatively or additionally, the item insight provider 224 may provide item insights to another service that can use the insights or provide the insights to a user device. For instance, the item insight provider 224 may provide the insights to a data feed service that can provide the insights to a user device accessing the data feed service.

Item insights may be provided for display in any number of ways. In some cases, the manner in which item insights are provided for display may depend on the application (e.g., application 120 of FIG. 1) to which the item insights are being provided. For instance, assume a user is accessing a document or file management application. Further assume a user selects a particular document or file (e.g., hovers over the item). In such a case, the item insight may be provided as text in a pop-up window near the selected document or file. As another example, assume a user is accessing an electronic communication application. In such a case, the item insight may appear in a pop-up window near a selected electronic communication or be included as a note, flag, or other indicator within the electronic communication.

As yet another example, in some cases, item insights may be provided in the form of a card. In this regard, the item insight provider 224 may provide a card, for example, generated via the item insight manager 222, including the appropriate item insights. A card generally refers to a card, window, or display portion that includes information associated with an item. In some cases, cards are presented in association with electronic communications or documents. In other cases, cards are presented in a data feed. A card may include any type of data, including indications of the item, collaboration network insights, item context insights, and/or the like.

In some cases, item insight provider 224 may include insight logic 236 to determine, rank, and/or aggregate item insights to provide. Insight logic 236 may include rules, conditions, associations, classification models, or other criteria, to identify or predict item insights. Insight logic 236 may take different forms depending on the mechanism used to determine items of interest. For example, insight logic 236 may comprise a statistical model, fuzzy logic, neural network, finite state machine, support vector machine, logistic regression, clustering, or machine-learning techniques, similar statistical classification processes, or combinations of these to identify item insights.

As described above, multiple item insights may be generated. For example, multiple item insights associated with different items may be generated. As another example, multiple item insights associated with a same item may be generated. In some implementations, various components may be used to generate different item insights. For example, a collaboration network insight generator may be used to generate collaboration network insights and an item context insight generator may be used to generate item context insights.

As multiple item insights may be generated, the item insight provider 224, for example via insight logic 236, may prioritize, rank, aggregate, or select particular insights to provide for display. In some cases, scores, priorities, or ranks may be provided in association with the item insight (e.g., from the item insight manager 222). For instance, the item context insight generator 228 may provide a score as metadata in association with an item context insight. Such scores, priorities, or ranks can then be used to prioritize or select item insights to provide to a user device. In other cases, the insight logic 236 may generate scores, ranks, or priorities for various insight items. Insight logic 236 may generate such values using, for example, recency of data, type of item insight, a type of application requesting the item insights, and/or the like. In this way, the item insight provider 224 may select which item insights to provide for presentation.

In some embodiments, the item insight provider 224 determines whether to generate a card for an item insight. For example, in some cases, cards may be generated for items and corresponding item insights associated with a higher priority or ranking (e.g., exceeding a threshold or a predetermined number of highest priority or ranking items). By way of example only, an item and corresponding item insight may be ranked higher based on recency of status changes, number of status changes, individual providing an action resulting in a status change, etc. As another example, cards may be generated for items and corresponding item insights when the insight request 252 is associated with a data feed service or other type of service that serves or provides cards.

As described, in some embodiments, a single card may be provided in relation to an item. For example, a first card may be provided with a first document, a second card may be provided with a second document, and so on. Accordingly, in such embodiments, the item insight provider 224 may aggregate item insights relevant to a particular item into one card. For example, in cases that a collaboration network insight generator 226 provides one card for an item and item context insight generator 228 provides another card for the same item, the item insight provider 224 may aggregate both insights into one card.

In some embodiments, the item insight provider 224 may generate cards. For instance, in some cases, item insights obtained at the item insight provider 224 may not be associated with a card. In such cases, the item insight provider 224 may generate a card for an item and incorporate one or more item insights associated with the item. In some instances, the item insight provider 224 may select a particular item insight or set of insights, from among candidate item insights, to include in the card. One example of a card is provided in FIG. 6A. As shown, card 604 includes a collaboration network insight 610 that indicates collaborators (e.g., individuals or entities) associated with the email item associated with the card. In this regard, for various items and corresponding collaboration networks, a card can be generated that provides an indication of the item and corresponding collaboration network. Similarly, card 604 illustrates an example item context insight 616 that provides context associated with the email item corresponding with card 604. Cards can be generated for various items to provide an indication of the item and corresponding context(s).

In some cases, a card may be generated for each item context. In this way, assume two different item contexts are identified in association with an item. In such a case, two different cards are generated. In other cases, a card is generated for a particular item and may include any number of related item contexts therein. In other implementations, the item context insight may be included in a previously generated card. Accordingly, in some embodiments, the item insight provider 224 may generate a card (or modify an already generated card) that includes a default set of information. In this way, cards can be generally structured in a similar manner. In other embodiments, the item insight provider 224 may use card logic 238 to dynamically determine a structure for the card. For example, card logic 238 may be used to determine which aspects of information to present, an order in which to present information, an extent of information to present, and/or the like. Card logic 238 may include rules, conditions, associations, classification models, or other criteria, to identify arrangement or presentation of data, including item insights, within a card. Card logic 238 may take different forms depending on the mechanism used to determine data arrangement or layout. For example, card logic 238 may comprise rules, logic, or instructions, which may include machine-learning techniques, crowdsourcing user feedback, and combinations of these to identify arrangement of data.

By way of example only, assume item insight manager 222 determines a collaboration network insight associated with an item and five different item context insights associated with the item. In such a case, card logic 238 may determine which of the item insights to provide in the card and an extent of each type to present. For instance, the card logic 238 may determine to present the collaboration network insight and two item context insights associated with the item. Such a determination may be based on user preferences, a user viewing the data, a size of display screen on which the card is being presented, a proportion of data identified (e.g., 10% of identified item context insights), a historical viewing or access of data by the user viewing the data, a recency of data (e.g., data associated with the last week, a predetermined number of most recent data), etc.

The item insight(s) 240 can be provided as output from the item insight provider 224. As described, the item insights may be provided in any number of forms for display via a user device. Alternatively or additionally, the item insight(s) 240 can be provided to the data store 214 and/or other service or system (e.g., a data feed service, a communication service, a document service, etc.).

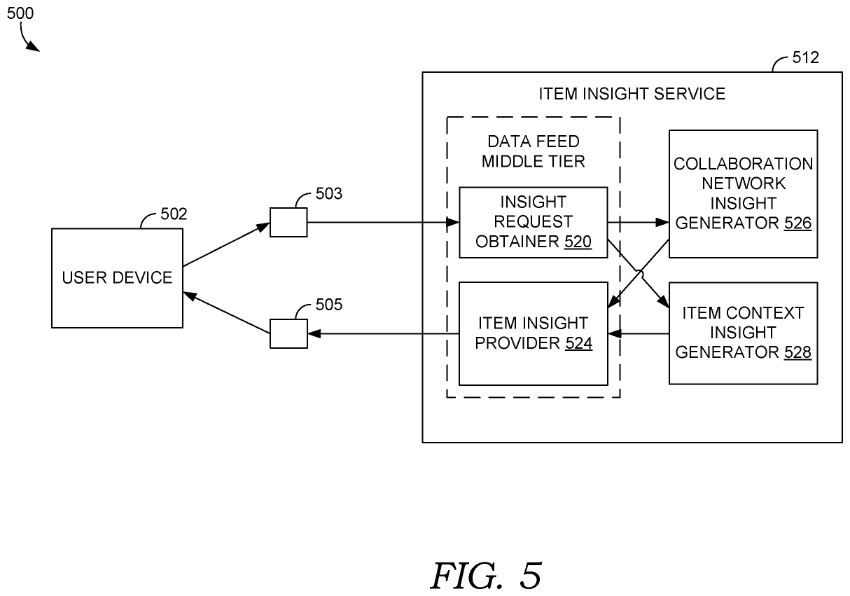

Turning to FIG. 5, FIG. 5 provides one example computer implementation 500 of an item insight service implemented in association with a data feed service. In this example, the user device 502 provides an insight request 503 to the item insight service 512. The insight request obtainer 520 obtains the insight request 503 and calls a set of insight generators. In this example, the insight request obtainer 520 receives the insight request 503 and calls collaboration network insight generator 526 and item context insight generator 528. As can be appreciated, generators 526 and 528 may be combined into a single insight generator to function as a single content generator. Further, additional insight or content generators or providers may additionally be called to obtain corresponding information. Collaboration network insight generator 526 and/or item context insight generator 528 may communicate with a data source or data store to obtain information to generate item insights. For example, a set of collaboration network data and various sets of item data may be accessed to identify a collaboration network for an item and/or context (e.g., modifications) associated with an item. In accordance with generating item insights, the collaboration network insight generator 526 and the item context insight generator 528 provide item insights to the item insight provider 524. As described herein, in some cases, the insight generators 526 and 528 may operate concurrently to generate the insights. In other cases, the insight generators may be operate in a serial manner. The item insight provider 524 can then aggregate the item insights (e.g., the collaboration network insight(s) and the item context insight(s)), rank the item insights, prune or select specific item insights, etc. to generate a response 505. The response 505 can provide the item insights and in some instances also provide an indication of the corresponding item. In some embodiments, the item insights are provided in the form of a card. For example, a card is provided for each item and can include any number of item insights associated with the particular item. In the example of FIG. 5, the insight request obtainer 520 and the item insight provider 524 may operate as a data feed middle tier that communicates with various insight generators and/or content providers of the item insight service.

### Example Implementations for Providing Item Insights

FIGS. 6A-6D provide example graphical user interfaces that illustrate various aspects of embodiments described herein for providing and utilizing item insights. In particular, a number of examples are now described showing different implementations of computer applications and user interfaces that make use of item insights. In some implementations, the item insights are provided via a new or modified graphical user interface to provide useful information to a user. In other implementations, the item insights enable new functionality of computer applications, such as surfacing content (e.g., a document), searching, filtering, or managing files. Turning first to FIG. 6A, a graphical user interface 600 is depicted with an example data feed 602. In this example, he data feed 602 includes a set of cards, illustrated as card 604, card 606, and card 608. As can be appreciated, a user may scroll down the data feed 602 to view more cards. In one embodiment, the cards are related to various items, such as by way of example and not limitation, documents, electronic communications, website searches, tasks, commitments, reminders, events, and activity of other users. In this example, card 604 is related to a new email message received by the user, card 606 is related to a task extracted from an instant messaging conversation, and card 608 is related to document updates. The cards may be presented in any order. For example, in some cases, the cards may be presented in an order based on a time associated with the card e.g., email sent time, document update time, an event associated with the card (for example, a deadline to reply to an email such as the email identified in card 604 or an upcoming meeting associated with the card or information provided via the card), a previous time the user viewed a card, or other time). In one example, a card associated with a most recent time may be displayed at the top of the data feed, or vice versa. Other aspects may be used to filter or order the cards, such as the type of item associated with a card (e.g., cards associated with tasks or commitments for the user may be ordered first, or similarly tasks having upcoming deadlines may be prioritized), a correlated collaboration network (e.g., cards associated with a higher prioritized collaboration network may be presented at the top of the data feed), a particular individual associated with a card (e.g., individual that sent a communication or made an update to a document), or the like.

As shown in FIG. 6A, each card includes a collaboration network insight. In this example, card 604 includes collaboration network insight 610, card 606 includes collaboration network insight 612, and card 608 includes collaboration network insight 614. Collaboration network insights 610 and 612 represent the collaboration network using an indication of the other aspects associated with the collaboration network, such as other users or entities. Collaboration network insight 614 represents the collaboration network using an indication of other users (e.g., via avatar representations). Collaboration network insight 614 also indicates a name or subject matter associated with the collaboration network (i.e., “2023 New Process Design”). In some instances, a presented collaboration network insight may be selected to provide more information. For example, collaboration network insight 610 may be selected to present information about another user or entity in the collaboration network. As can be appreciated, these are only examples for representing a collaboration network and any number of designs can be implemented.

In some embodiments, cards include an item context insight. In this example, card 604 includes item context insight 616, and card 608 includes item context insight 618. Item context insight 616 provides an indication that another collaborator has replied to the email, but that the user has not yet read the email. Item context insight 618 provides an indication that collaborators have commented on a particular document since the user last viewed the document.

As can be appreciated, various other item context insights may be provided. For example, with reference to FIG. 6B, additional example cards 620, 622, 632, and 638 are depicted having various item insights. With respect to card 620, a collaboration network insight 622 and an item context insight 624 are provided. The item context insight 624 indicates that collaborators, such as other users in a collaboration network with the user, have updated the file since the user last viewed the document. Card 626 includes a collaboration network insight 628 and an item context insight 630. The item context insight 630 indicates that collaborators have commented on the document since the user last viewed the document. Card 632 includes a collaboration network insight 634 and an item context insight 636. The item context insight 636 indicates that a collaborator has replied to the user's comment, and the user has not yet viewed the reply. Card 638 includes a collaboration network insight 640 and an item context insight 642. The item context insight 642 indicates that a collaborator has made a number of modifications since the user last viewed the document. In some cases, a presented item context insight may be selected to provide more information. For example, item context insight 618 may be selected to present the comments.

With regards to the examples depicted in FIGS. 6A, 6B, 6C, and 6D, and as described herein, item context insights can be generated and/or presented in any number of ways. For example, for a particular item, a context associated with the item is determined and used to generate or identify an item context insight. In some cases, items for which to provide an item context insight may be determined based on items identified within cards of a data feed and/or items for which a collaboration network is identified. In other cases, items for which to provide a collaboration network insight may be determined based on another attribute, such as a date associated with the item, a status change (e.g., a modified document), or the attributes described above in connection with a collaboration network insight. By way of example, for the document item associated with card 608, an item context insight associated with that particular document is determined. Determining to provide an item context insight might be based on, for instance, the determination that item (e.g., the document or other file) was recently updated. To determine an item context, data associated with the item may be referenced or used. For example, this item data may comprise edits, views, accesses, changes, comments, senders, receivers, or other activities associated with an item. In this regard, item data previously generated may be accessed to determine a particular context associated with the item. Upon identifying an appropriate item context, a corresponding insight can be generated.

Generally, an item context insight includes an indication or identification of a context associated with the item. In some embodiments, an item context insight includes an indication or identification of context that is also relevant to the user. For instance, the item context insight might specify that the particular item has been modified since last viewed by the user, has been modified a particular number of times since last viewed by the user, has been modified by a particular set of individuals since last viewed by the user, etc. Generally, the item context insight provides insight as to why a user may desire to view the item (e.g., the document). In accordance with generating the item context insight, a card such as cards depicted in FIGS. 6A and 6B, can be created to include the context insight, or the context insight can be added to a previously generated card for presentation. In some embodiments, the generated item context insight is used by a computer application to provide information to a user or to perform application operations using the item context insight, such as in the file manager application in FIG. 6C and the email-communications program depicted in 6D.

As shown in FIG. 6B, example cards 620, 622, 632, and 638 having item insights are not shown as being associated with a data feed, such as data fed 602 of FIG. 6A. While it is contemplated that the example cards 620, 622, 632, and 338 could be provided to a user via a data feed, a card having an item insight may be provided in any number of other ways, in some embodiments. For example, in one embodiment, a card having an item insight is provided as a live persona card or as part of a user-profile card. For instance in response to a user selecting a person's name, avatar, or selecting another indication of the person, such as by hovering the user's cursor over the indication of the person, a card is presented with information about that person. In this example embodiment, the card includes an item insight.

In some embodiments, a particular item insight provided in a card is tailored to the particular application or use case of the user who is being presented the card. For example, where a document has a comment by a particular collaborator such as another person in a collaboration network with a user, the user selecting the collaborator's name or avatar in the comment, such as by hovering their cursor over an indication of the collaborator, is presented a card associated with the collaborator, and within that card is provided an item insight. The item insight may comprise a collaboration network insight such as an indication that this document is related to your work on a particular project. Alternatively or in addition, the item insight may comprise an item context insight, such as an item insight that is tailored to a particular application or use case of the user. In one example, the item context insight indicates that specific users in the collaboration network have not yet accessed the document. This item context insight is helpful for the user because the user may desire to hold off reviewing comments until others in their collaboration network have read the document. As another example, during an online meeting using a communications application, such as Teams by Microsoft®, a user selecting an indication of another meeting attendee, such as by hovering their cursor over an avatar or other indication of the attendee, is presented a card associated with that attendee, and within that card is provided an item insight. The item insight may comprise a collaboration network insight indicating a particular collaboration network of which the user and the attendee belong and/or other people in a particular collaboration network of which the user and the attendee belong. Alternatively or in addition, the item insight may comprise an item context insight tailored to the particular context of the online meeting. For instance, the item context insight may indicate that the attendee sent the user an email about the meeting that the user has not yet viewed (similar to the example item context insight depicted in card 604 of FIG. 6A. As can be appreciated, these are only examples for representing item insights via cards, and any number of alternative designs can be implemented including other types of cards as well as item insights provided within other computing applications such as depicted in FIGS. 6C and 6D.

With respect to FIG. 6C, an example graphical user interface 650 is provided of a file manager computer application 655 (such as File Explorer and SharePoint® by Microsoft®). In this example, file manager application 655 shows various files 660 of a computer system, such as computing device 1000 described in FIG. 10. In this example, in response to a user placing the cursor on a particular file 662, metadata 670 regarding file 662 is presented to the user. In some cases, based on the selection of the particular file 662, embodiments herein generate a corresponding collaboration network insight corresponding with the particular file 662. Alternatively, in some embodiments, a collaboration network insight corresponding with a particular file 662 may be determined before the selection of the file; for example, in one embodiment a computer service operating on the computer system generates a collaboration network insight in advance, such as subsequent to creating the file or determining that the file is associated with the collaboration network. Further, in some embodiments, the collaboration network insight is stored in metadata associated with the file. In this way, the collaboration network associated with the particular file 662 is identified and, thereafter, used to create or present the collaboration network insight 675. Similarly, in this way based on the selection of the particular file 662, a previously generated corresponding collaboration network insight may be accessed or referenced for presentation. For instance, collaboration network insights may be generated in advance such that when requested for viewing the insight is presented without needing to generate the insight. In this example, metadata 670 includes collaboration network insight 675 indicating that the particular file 662 is related to the user's work with Kristen Nygaard and four others. As can be appreciated, some implementations of file manager application 655 enable a user to search for or filter files based on metadata. Accordingly, file manager application 655 is further enabled to manage and process files according to collaboration network insights, such as collaboration network insight 675. For example, a user may search on or select a filter as so to see only files that are related to this particular work with Kristen Nygaard and four others. In this regard, metadata may be accessed and used to facilitate the search or filter to identify items associated with the particular collaboration network. For instance, assume Document C and Document D are both associated with the same collaboration network, in this case, related to work with Kristen Nygaard and 4 others. Now assume a user inputs a collaboration network identifier in the search box (e.g., the name of Kristen Nygaard, or an indication of another user or entity associated with the collaboration network). In such a case, Document C and Document D may be presented or visually highlighted to indicate items associated with that desired collaboration network.

Turning to FIG. 6D, an example graphical user interface 680 is provided of a communications computer application 685. In this example, communications computer application 685 comprises an email application (such as Outlook by Microsoft®). In other instances, a communications computer application comprises a collaboration application, such as Microsoft Teams®, or a messaging application. Example communications computer application 685 depicts an email message 690 from to recipient Lars from sender Ingrid. Communications computer application 685 further depicts a collaboration network insight 692 for the particular email message 690. In particular, in the example implementation depicted in FIG. 6D, new functionality of communications computer application 685 is provided for presenting an indication of a collaboration network insight that is determined for a particular item (here, the item is an email message). In this example, the item insight 692 indicates that the email message 690 appears to be related to Lars' collaboration network with Kristin, Jens, and three others. As can be appreciated, there could be other email to Lars from Ingrid (not shown) that is not related this particular collaboration network. Accordingly collaboration network insight 692 may be utilized via communications computer application 685 to more efficiently enable a user like Lars to locate, identify, filter, and manage email relevant to Lar's a particular collaboration. In this example, generation and presentation of a collaboration network insight may occur automatically upon receipt of an email or accessing of an email. For example, in accordance with an email being received, the collaboration network insight 692 may be generated and included in metadata such that it is presented in the email. As another example, in accordance with opening the email, the collaboration network insight 692 may be generated and included in the email.

With reference to FIGS. 6A, 6B, 6C and 6D, collaboration network insights and context network insights can be generated, presented, and/or utilized by computing applications in any of a number of ways. In some cases, in association with accessing an application, a data feed, such as data feed 602 of FIG. 6A, can be automatically presented, or presented upon a selection to view the data feed. In accordance with generating and presenting the data feed 602, embodiments described herein facilitate generation of collaboration network insights and/or item context insights such that the item insights are presented along with cards in the data feed, as appropriate. In one embodiment, for a particular item, an associated collaboration network is identified. In another embodiment, for a particular item, an aspect of a collaboration network is identified, such as a person, or entity name (for example, a project name, computer file, event, or communication), or other indication associated with collaboration network. In some cases, items for which to provide an item insight may be determined based on items identified within cards, such as the example cards described in connection with FIGS. 6 and 6B. In some cases items for which to provide an item insight may be determined based on a particular collaboration network or a determination that the item is associated with the collaboration network.

In some embodiments, items for which to provide a collaboration network insight may be determined based on an attribute associated with the item, such as a date associated with the item, a status change (for example, a modified document), a particular person who accessed (or otherwise interacted with) an item, an activity performed or not performed by the user (for example, attending or not attending an event), or an attribute associated with the user or a collaboration network. By way of example and without limitation, for the document associated with card 608 of FIG. 6A, a collaboration network associated with that particular document is identified. In this example, the identified collaboration network is indicated as “2023 New Process Design Work.” Determining to provide a collaboration network insight might be based on, for instance, a first identification that a file was recently created or updated, and a second identification of a collaboration network associated with the created or updated file. In some cases, such identification of a collaboration network is performed using or referencing collaboration network data. For example, in one embodiment, collaboration network data comprises a document identifier used to lookup a collaboration network to which the document belongs, and which may comprise metadata associated with the document. In another embodiment, collaboration network data is referenced via a database, such as a relational database having records associated with an entity or a user of the collaboration network.

In some embodiments, based on a first determination that an item, such as a file, is associated with a collaboration network, a computer service that is a computer program, checks the status of the file to determine if a collaboration network insight should be provided regarding the item. For example, the computer service may determine that a file has been accessed, shared, or a status associated with the file (which may be indicated from an attribute associated with the file) has otherwise changed such that an item insight regarding the file is warranted. In some embodiments, the computer service may check items associated with the collaboration network periodically, may monitor items, designate the items on a watch list, or may check the item when certain computer system operations occur or are detected that can result in modifying the status of an item, such as an access operation or a file sharing operation.

Upon identifying the appropriate collaboration network for an item, the corresponding item insight can be generated. In embodiments, the collaboration network insights includes an indication or identification of the collaboration network (e.g., by a name, by indicating collaborator identifications, and/or the like). In accordance with generating the collaboration network insight, a card can be created to include the insight, or the insight can be added to a previously generated card for presentation. In other embodiments, the generated collaboration network insight is used by a computer application to provide useful context to a user or to perform application operations using the collaboration network insight, such as in the file manager application in FIG. 6C and the email-communications program depicted in 6D.

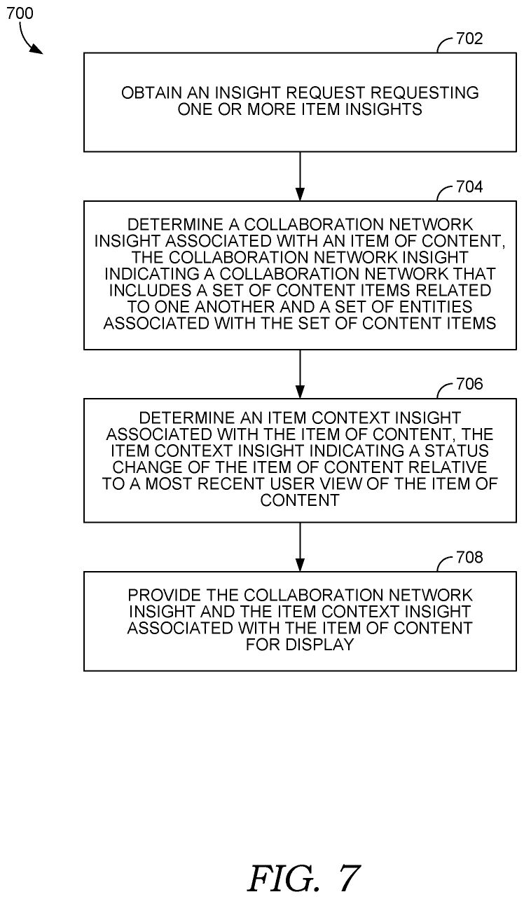

Turning now to FIGS. 7, 8, and 9, aspects of example process flows 700, 800, and 900 are illustratively depicted for some embodiments of the present disclosure. Embodiments of process flows 700, 800, and 900 each comprise a method (sometimes referred to herein as method 700, 800, and 900) carried out to implement various example embodiments described herein. For instance, at least one of method 700, 800, or 900 are performed to programmatically generate and/or provide an item insight. The process flows represented in FIGS. 7-9 are intended to be example in nature and not limiting.

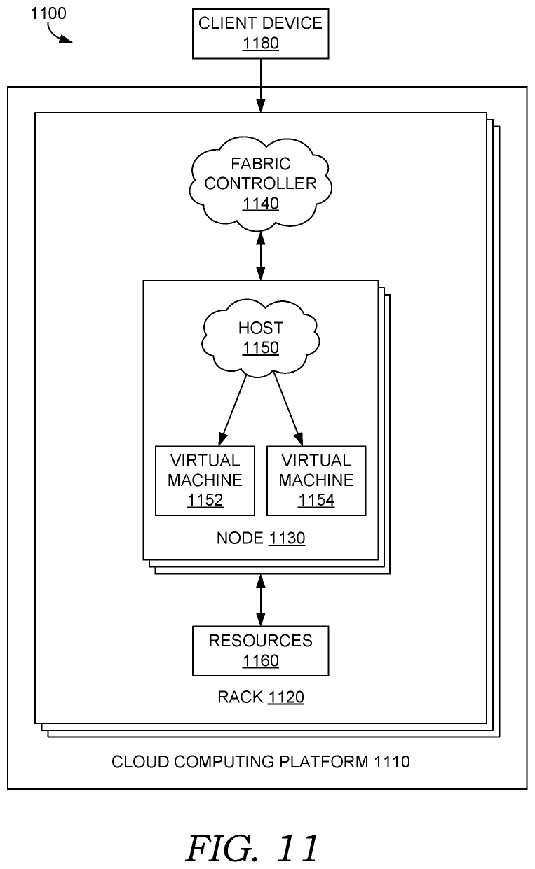

Each block or step of method 700, 800, or 900, and other methods described herein comprises a computing process performed using any combination of hardware, firmware, and/or software. For instance, various functions are carried out by a processor executing instructions stored in memory, such as memory 1012 as described in FIG. 10, data store 114 as described in FIG. 1, and/or as data store 214 as described in FIG. 2. Embodiments of the methods are also be embodied as computer-usable instructions stored on computer storage media. Embodiments of the methods are provided by a stand-alone application, a computing service or hosted service (stand-alone or in combination with another hosted service), or a plug-in to another product, to name a few. For example, the blocks of method 700, 800, and 900 that correspond to actions (or steps) to be performed (as opposed to information to be processed or acted on) are carried out by one or more computer applications or services, in some embodiments, which operate on one or more user devices (such as user device 110A of FIG. 1), a server, and/or are distributed across multiple user devices, and/or servers, or by a distributed computing platform, and/or are implemented in the cloud, such as described in connection with FIG. 11. In some embodiments, the functions performed by the blocks or steps of methods 700, 800, and 900 are carried out by components of implementations 200 and 500, as described in FIGS. 2 and 5.

Turning initially to method 700 of FIG. 7, method 700 is directed to facilitating generating and providing item insights, in accordance with embodiments of the present technology. Initially, at block 702, an insight request requesting one or more item insights is obtained. In some cases, the insight request includes an indication of the item of content. In other cases, the item of content may be determined (e.g., based on analysis of item data). An item of content may include, for example, a document, a file, an email, an instant message, a text message, a calendar event, and/or a search result. At block 704, a collaboration network insight associated with an item of content is determined. The collaboration network insight may indicate a collaboration network that includes a set of content items related to one another and a set of entities associated with the set of content items. In one implementation, the collaboration network insight is determined by accessing a set of collaboration network data. The set of collaboration network data may include the collaboration network, including the item of content, associated with a user, and may include another collaboration network, excluding the item of content, associated with the user. At block 706, an item context insight associated with the item of content is determined. In embodiments, the item context insight indicates a status change of the item of content relative to a most recent user view of the item of content. A status change of an item may include, for example, a modification of the item of content or a modification of metadata associated with the item of content. At block 708, the collaboration network insight and the item context insight associated with the item of content are provided for display. For example, the collaboration network insight and the item context insight can be presented in a card for display in a data feed.

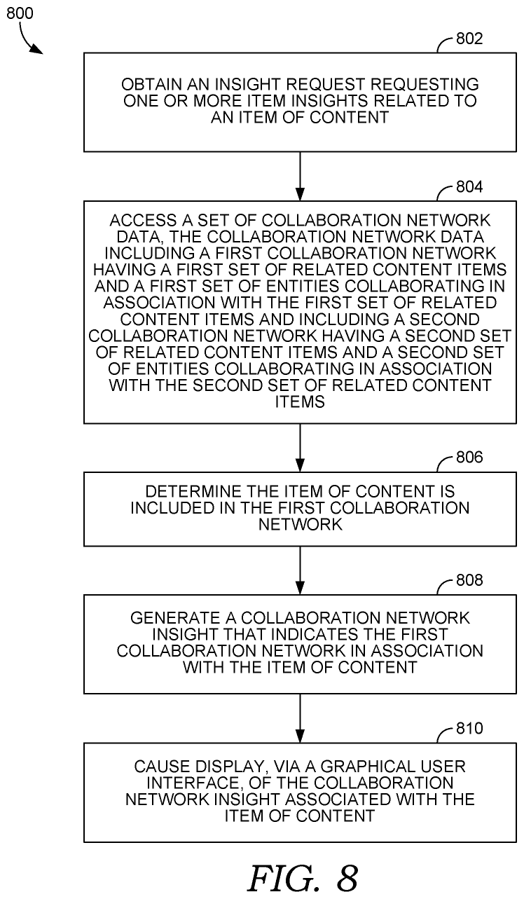

Turning now to FIG. 8, method 800 is directed to generating and providing a collaboration network insight, in accordance with embodiments of the present technology. Initially, at block 802, an insight request requesting one or more item insights related to an item of content is obtained. For example, an insight request may be communicated from a user device. In some cases, the insight request may indicate the item of content. In other cases, an item of content may be determined or identified. At block 804, a set of collaboration network data is accessed. The collaboration network data may a first collaboration network having a first set of related content items and a first set of entities collaborating in association with the first set of related content items and include a second collaboration network having a second set of related content items and a second set of entities collaborating in association with the second set of related content items. A set of related content items may include, for example, documents, files, media, emails, instant messages, text messages, or a combination thereof. At block 806, it is determined that the item of content is included in the first collaboration network. At block 808, a collaboration network insight that indicates the first collaboration network in association with the item of content is generated. The first collaboration network may be identified in any number of ways, such as by referencing one or more entities associated with the first collaboration network. At block 810, the collaboration network insight associated with the item of content is caused to be displayed via a graphical user interface. In some embodiments, the collaboration network insight is presented in a card displayed in a data feed. Additionally or alternatively, the collaboration network insight is presented in relation to the item of content selected via the graphical user interface.

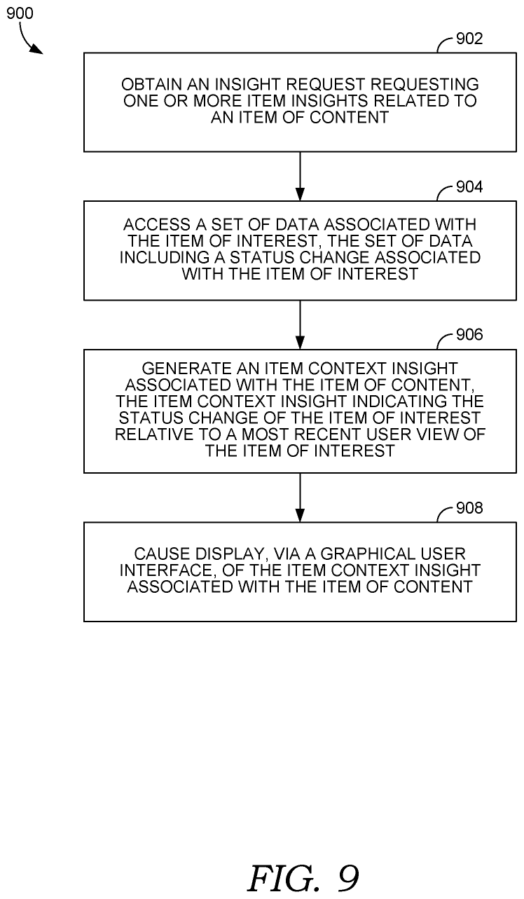

With reference now to FIG. 9, method 900 is directed to facilitating generating and providing item context insights, in accordance with embodiments of the present technology. Initially, at block 902, an insight request requesting one or more item insights related to an item of content is obtained. For example, an insight request may be communicated from a user device. In some cases, the insight request may indicate the item of content. In other cases, an item of content may be determined or identified. At block 904, a set of data associated with the item of interest is accessed. The set of data may include a status change associated with the item of interest. In some cases, a status change may include a modification of the time of content or a modification of metadata associated with the item of content. At block 906, an item context insight associated with the item of content is generated. In embodiments, the item context insight indicates the status change of the item of interest relative to a most recent user view of the item of interest. One or more rules may be used to identify an item context insight(s) associated with the item of content. At block 908, display, via a graphical user interface, of the item context insight associated with the item of content is caused. In some embodiments, the item context insight is presented in a card displayed in a data feed. In other embodiments, the item context insight is presented in relation to the item of content selected via the graphical user interface.

Accordingly, we have described various aspects of technology directed to systems, methods, and graphical user interfaces for intelligently determining and providing item insights. It is understood that various features, sub-combinations, and modifications of the embodiments described herein are of utility and may be employed in other embodiments without reference to other features or sub-combinations. Moreover, the order and sequences of steps shown in the example methods 700, 800, and 900 are not meant to limit the scope of the present disclosure in any way, and in fact, the steps may occur in a variety of different sequences within embodiments hereof. Such variations and combinations thereof are also contemplated to be within the scope of embodiments of this disclosure.

### OTHER EMBODIMENTS

In some embodiments, a computerized system, such as the computerized system described in any of the embodiments above, comprises one or more processors, and one or more computer storage media storing computer-useable instructions that, when executed by the one or more processors, cause the one or more processors to perform operations. The operations comprise receiving an insight request comprising an indication of a content item for which an item insight, corresponding to the content item, is to be determined, and based on an indication of the content item in the insight request, determining a collaboration network that is associated with the content item and a user. The operations may further comprise generating a collaboration network indicator corresponding to the content item, the collaboration network indicator indicating at least an aspect of the collaboration network. The operations may further comprise causing to present, with presentation of an indication of the content item, at least the collaboration network indicator. For example, the collaboration network indicator may be presented for display via the computerized system. In this way, these embodiments of this disclosure enable an improved user experience across a number of computer devices, applications and platforms. Also in this way, embodiments, as described herein, enable very large scale of operations created by software-based services that cannot be managed by humans to operate in an efficient manner while determining and providing item insights. Further, in this way, and as described herein, some embodiments cause certain item insights to be programmatically surfaced and presented without requiring computer tools and resources for a user to manually perform operations to produce this outcome.

In any combination of the above embodiments of the computerized system, the operations further comprise determining an item context associated with the content item, the item context indicating a status of the content item relative to the user. The operations may further comprise generating an item context indicator indicating the determined item context. The operations may further comprise causing to present, with presentation of an indication of the content item, the item context indicator. For example, the item context indicator may be presented for display via the computerized system.

In any combination of the above embodiments of the computerized system, the collaboration network indicator and the item insight indicator are caused to be presented in a card that includes the presentation of the indication of the content item.

In any combination of the above embodiments of the computerized system, the insight request is generated based on a determination by an item insight service, which is a computer service operating on the computing system, to obtain an item insight for the content item.

In any combination of the above embodiments of the computerized system, the insight request is received from a computer application operating on the computing system, and based on an indication of the content item by the computer application.

In any combination of the above embodiments of the computerized system, the computer application comprises one of a data feed application, a file manager application, or communications application, or a search application.

In any combination of the above embodiments of the computerized system, for the data feed application, the collaboration network indicator is caused to be presented in a card comprising the presentation of the indication of the content item, the card being provided to the user via the data feed application.

In any combination of the above embodiments of the computerized system, for the file manager application, the search application, or the communications application, the collaboration network indicator is caused to be presented proximate the presentation of the indication of the content item.

In any combination of the above embodiments of the computerized system, the collaboration network includes a set content items and a set of entities associated with the set of content items, the set of entities including one or more people who contributed to or have access to at least a portion of the set of content items.

In any combination of the above embodiments of the computerized system, the collaboration network associated with the content item and user is determined based on accessing collaboration network data comprising indications of at least one collaboration network, and determining the collaboration network that includes the content item and the user.

In any combination of the above embodiments of the computerized system, the aspect of the collaboration network indicated by the collaboration network indicator comprises at least a portion of the set of entities associated with the set of content items.

In any combination of the above embodiments of the computerized system, the content item comprises a document, a file, an email, an instant message, a text message, a calendar event, an indication of another user, or a search result.

In any combination of the above embodiments of the computerized system, the status of the content item comprises information indicating a change or no change of the content item, change or no change of metadata associated with the content item, access or non-access of the content item by the user or by another person, or an action associated with the content item that is taken or not taken.

In other embodiments, a computer-implemented method is provided. The method includes accessing a set of collaboration network data. The collaboration network data includes a first collaboration network associated with a user and having a first set of related content items and an indication of a first set of entities associated with the first set of related content items. The collaboration network data further includes a second collaboration network associated with the user and having a second set of related content items and an indication of a second set of entities associated with the second set of related content items. The method may further include determining, based on at least a portion of the set of collaboration network data, the item of content is included in the first collaboration network. The method may further include generating a collaboration network indicator that indicates an aspect of the first collaboration network. The method may further include causing display, via a graphical user interface and with a presentation of an indication of the item of content, the collaboration network indicator. For example, an indication of the item of content, such as a document, maybe presented along with a corresponding collaboration network indicator. The presentation may be provided in a card, file manager, or other computer application. In this way, these embodiments of this disclosure enable an improved user experience across a number of computer devices, applications and platforms. Also in this way, embodiments, as described herein, enable very large scale of operations created by software-based services that cannot be managed by humans to operate in an efficient manner while determining and providing item insights. Further, in this way, and as described herein, some embodiments cause certain item insights to be programmatically surfaced and presented without requiring computer tools and resources for a user to manually perform operations to produce this outcome.

In any combination of the above embodiments of the computer-implemented method, the collaboration network indicator is presented via a card displayed in a data feed associated with the user, the card including the indication of the content item.

In any combination of the above embodiments of the computer-implemented method, the collaboration network indicator is presented to provide context based on the user selection of the item of content displayed in the graphical user interface.

In any combination of the above embodiments of the computer-implemented method, the aspect of the collaboration network indicated by the collaboration network indicator comprises at least a portion of the first set of entities.

In any combination of the above embodiments of the computer-implemented method, the first set of related content items comprise documents, files, media, emails, instant messages, text messages, or a combination thereof.

In any combination of the above embodiments of the computer-implemented method, the set of collaboration network data is accessed in response to receiving, from a computer application, an insight request comprising an indication of the item of content.

In any combination of the above embodiments of the computer-implemented method, the computer application comprises one of a data feed application, a file manager application, or communications application, or a search application.

In any combination of the above embodiments of the computer-implemented method, for the data feed application, the collaboration network indicator is displayed in a card that displays the indication of the item of content, the card being provided to the user via the data feed application.

In any combination of the above embodiments of the computer-implemented method, for the file manager application, the search application, or the communications application, the collaboration network indicator is displayed proximate the presentation of the indication of the item of content.

In other embodiments, a computer-implemented method is provided for presenting insights in a graphical user interface that is operating on a computer system. The method includes causing display, via the graphical user interface, of an indication of an item of content. The method further includes causing display, via the graphical user interface, of a collaboration network insight associated with the item of content. In these embodiments, the collaboration network insight may comprise a collaboration network indicator that indicates at least an aspect of a collaboration network associated with a user and having a set of content items related to one another and a set of entities associated with the set of content items. The method may further include causing display, via the graphical user interface, of an item context insight associated with the item of content, the item context insight comprising information regarding a status of the item of content relative to the user. The item context insight may comprise an item context indicator. In this way, these embodiments of this disclosure enable an improved user experience across a number of computer devices, applications and platforms. Also in this way, embodiments, as described herein, enable very large scale of operations created by software-based services that cannot be managed by humans to operate in an efficient manner while determining and providing item insights. Further, in this way, and as described herein, some embodiments cause certain item insights to be programmatically surfaced and presented without requiring computer tools and resources for a user to manually perform operations to produce this outcome.

In any combination of the above embodiments of the computer-implemented method, the graphical user interface presents aspects of a data feed including a card.

In any combination of the above embodiments of the computer-implemented method, the collaboration network insight and the item context insight are automatically presented in the card with an indication of the item of content.

In any combination of the above embodiments of the computer-implemented method, the collaboration network insight or the item context insight is presented subsequent to receiving an insight request that is generated based on a user interaction with the item of content via the graphical user interface.

In any combination of the above embodiments of the computer-implemented method, the aspect of the collaboration network comprises at least a portion of the set of entities.

In any combination of the above embodiments of the computer-implemented method, the graphical user interface comprises one of a card in a data feed, a file manager application interface, or an electronic communications application interface.

In any combination of the above embodiments of the computer-implemented method, the indication of the item of content, the collaboration network insight, and the item context insight are concurrently presented.

In other embodiments, a computerized system, such as the computerized system described in any of the embodiments above, comprises one or more processors, and one or more computer storage media storing computer-useable instructions that, when executed by the one or more processors, cause the one or more processors to perform operations. The operations comprise, for an item of content, determining a collaboration network, from among a set of collaboration networks, to which the item of content corresponds and to which a user is associated, the collaboration network including at least a set of content items related to one another. The operations may further comprise generating a collaboration network insight associated with the item of content, the collaboration network insight generated by providing an indication of the corresponding collaboration network. The operations may further comprise determining an item context associated with the item of content, the item context indicating a status of the item of content relative to the user. The operations may further comprise generating an item context insight for the item of content, the item context insight generated by providing an indication of the determined item context. The operations may further comprise causing to present the collaboration network insight and the item context insight associated with the item of content. For example, the collaboration network insight and/or the item context insight may be presented for display via the computerized system. In this way, these embodiments of this disclosure enable an improved user experience across a number of computer devices, applications and platforms. Also in this way, embodiments, as described herein, enable very large scale of operations created by software-based services that cannot be managed by humans to operate in an efficient manner while determining and providing item insights. Further, in this way, and as described herein, some embodiments cause certain item insights to be programmatically surfaced and presented without requiring computer tools and resources for a user to manually perform operations to produce this outcome.

In any combination of the above embodiments of the computerized system, the operations further comprise receive a request for an item insight, the request including an indication of the item of content.

In any combination of the above embodiments of the computerized system, the operations further comprise selecting the item of content, from among a plurality of items of content, based on relevance to the user.

In any combination of the above embodiments of the computerized system, the collaboration network associated with the item of content is determined by: accessing a set of collaboration network data, the set of collaboration network data having the collaboration network, including the item of content, associated with the user and having another collaboration network, excluding the item of content, associated with the user; and determining that the item of content corresponds with the collaboration network.

In any combination of the above embodiments of the computerized system, the collaboration network includes a set of entities associated with the set of content items, the set of entities including indications of individuals that contributed to or have access to at least a portion of the set of content items.

In any combination of the above embodiments of the computerized system, the item of content comprises a document, a file, an email, an instant message, a text message, a calendar event, an indication of another user, or a search result.

In any combination of the above embodiments of the computerized system, the status of the item of content comprises an indication of a modification of the item of content or a modification of metadata associated with the item of content.

In any combination of the above embodiments of the computerized system, the collaboration network insight and the item context insight are provided in a card for concurrent display in a data feed that is associated with the user.

In any combination of the above embodiments of the computerized system, the operations further comprise selecting the item context insight, from among a plurality of item context insights associated with the item of content, based on relevance to the user.

In any combination of the above embodiments of the computerized system, the collaboration network includes a set of entities associated with the set of content items and wherein the collaboration network is indicated in the collaboration network insight via at least a portion of the set of entities associated with the set of content items.

In other embodiments, a computer-implemented method is provided. The method includes accessing a set of collaboration network data. The collaboration network data may include a first collaboration network associated with a user and having a first set of related content items and a first set of entities collaborating in association with the first set of related content items. The collaboration network data may further include a second collaboration network associated with the user and having a second set of related content items and a second set of entities collaborating in association with the second set of related content items. The method may further include determining the item of content is included in the first collaboration network. The method may further include generating a collaboration network insight that indicates the first collaboration network in association with the item of content. The method may further include causing display, via a graphical user interface, of the collaboration network insight associated with the item of content. In this way, these and other embodiments of this disclosure enable an improved user experience across a number of computer devices, applications and platforms. Also in this way, embodiments, as described herein, enable very large scale of operations created by software-based services that cannot be managed by humans to operate in an efficient manner while determining and providing item insights. Further, in this way and as described herein, some embodiments cause certain item insights to be programmatically surfaced and presented without requiring computer tools and resources for a user to manually perform operations to produce this outcome.

In any combination of the above embodiments of the computer-implemented method, the collaboration network insight is presented via a card displayed in a data feed associated with the user.

In any combination of the above embodiments of the computer-implemented method, the collaboration network insight is presented to provide context based on the user selection of the item of content displayed in the graphical user interface.

In any combination of the above embodiments of the computer-implemented method, the first collaboration network is represented in the collaboration network insight via an indication of at least a portion of the first set of entities.

In any combination of the above embodiments of the computer-implemented method, the first set of related content items comprise documents, files, media, emails, instant messages, text messages, or a combination thereof.

In other embodiments, a computer-implemented method is provided for presenting insights in a graphical user interface that is operating on a computer system. The method includes causing display, via the graphical user interface, of an indication of an item of content. The method may further include causing display, via the graphical user interface, of a collaboration network insight associated with the item of content. In these embodiments, the collaboration network insight indicates a collaboration network associated with a user and having a set of content items related to one another and a set of entities associated with the set of content items. The method may further include causing display, via the graphical user interface, of an item context insight associated with the item of content, the item context insight indicating a status of the item of content relative to the user.

In any combination of the above embodiments of the computer-implemented method, the item context insight is presented to provide context based on a selection by the user of the item of content displayed in the graphical user interface.

In any combination of the above embodiments of the computer-implemented method, the graphical user interface presents aspects of data feed including a card, and wherein the collaboration network insight and the item context insight are automatically presented in the card.

In any combination of the above embodiments of the computer-implemented method, the collaboration network insight indicates the collaboration network and wherein the collaboration network insight is presented based on a user selection of the item of content displayed in the graphical user interface.

In any combination of the above embodiments of the computer-implemented method, the graphical user interface comprises one of a card in a data feed, a file manager application interface, or an electronic communications application interface, and wherein the indication of the item of content, the collaboration network insight, and the item context insight are concurrently presented.

### Example Computing Environments

Having described various implementations, several example computing environments suitable for implementing embodiments of the disclosure are now described, including an example computing device and an example distributed computing environment in FIGS. 10 and 11, respectively. With reference to FIG. 10, an example computing device is provided and referred to generally as computing device 1000. The computing device 1000 is but one example of a suitable computing environment and is not intended to suggest any limitation as to the scope of use or functionality of embodiments of the disclosure. Neither should the computing device 1000 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

Some embodiments comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low level functions relating to, for example, logic, control, and memory operations. Low level software written in machine code can provide more complex functionality to higher levels of software. Accordingly, in some embodiments, computer-executable instructions may include any software, including low level software written in machine code, higher level software, such as application software, and any combination thereof. In this regard, the system components can manage system resources and provide services for system functionality. Any other variations and combinations thereof are contemplated with embodiments of the present disclosure.

With reference to FIG. 10, computing device 1000 includes a bus 1010 that directly or indirectly couples the following devices: memory 1012, one or more processors 1014, one or more presentation components 1016, one or more input/output (I/O) ports 1018, one or more I/O components 1020, and an illustrative power supply 1022. Bus 1010 represents what may be one or more buses (such as an address bus, data bus, or combination thereof). Although the various blocks of FIG. 10 are shown with lines for the sake of clarity, in reality, these blocks represent logical, not necessarily actual, components. For example, a presentation component such as a display device may be considered to be an I/O component. Also, processors have memory. Accordingly, it is recognized that such is the nature of the art and thus the diagram of FIG. 10 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 10 and with reference to “computing device.”

Computing device 1000 typically includes or uses a variety of computer-readable media. Computer-readable media can be any available media that can be accessed by computing device 1000 and includes both volatile and nonvolatile, removable and non-removable media. By way of example, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes random access memory (RAM), read only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other hardware medium which can be used to store the desired information and which can be accessed by computing device 1000. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, communication media includes wired media, such as a wired network or direct-wired connection, and wireless media, such as acoustic, radio frequency (RF), infrared, and other wireless media. Combinations of any of the above should also be included within the scope of computer-readable media.

Memory 1012 includes computer storage media in the form of volatile and/or nonvolatile memory. The memory may be removable, non-removable, or a combination thereof. Example hardware devices include, for example, solid-state memory, hard drives, and optical-disc drives. Computing device 1000 includes one or more processors 1014 that read data from various entities such as memory 1012 or I/O components 1020. As used herein, the term processor or “a processer” may refer to more than one computer processor. For example, the term processor (or “a processor”) may refer to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, cloud computing system, or parallel processing by more than a single processor. Further, various operations described herein as being executed or performed by a processor may be performed by more than one processor.

Presentation component(s) 1016 present data indications to a user or other device. Example presentation components include a display device, speaker, printing component, vibrating component, and the like. The I/O ports 1018 allow computing device 1000 to be logically coupled to other devices, including I/O components 1020, some of which may be built in. Illustrative components include a keyboard, touch screen or touch-sensitive surface, microphone, camera, mouse, joystick, game pad, satellite dish, scanner, printer, or a wireless peripheral device. The I/O components 1020 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000 may be equipped with depth cameras, such as stereoscopic camera systems, infrared camera systems, RGB camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

Some embodiments of computing device 1000 may include one or more radio(s) 1024 (or similar wireless communication components). The radio transmits and receives radio or wireless communications. The computing device 1000 may be a wireless terminal adapted to receive communications and media over various wireless networks. Computing device 1000 may communicate via wireless protocols, such as code division multiple access (CDMA), global system for mobiles (GSM), or time division multiple access (TDMA), as well as other wireless protocols, to communicate with other devices. The radio communications may be a short-range connection, a long-range connection, or a combination of both a short-range and a long-range wireless telecommunications connection. Short-range and long-range types of connections do not refer to the spatial relation between two devices, but instead refers to short range and long range as different categories, or types, of connections (for example, a primary connection and a secondary connection). A short-range connection may include, by way of example, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example, one or more of CDMA, General Packet Radio Service (GPRS), GSM, TDMA, and 802.16 protocols, or other long-range communication protocols used by mobile devices.

Referring now to FIG. 11, an example distributed computing environment 1100 is illustratively provided, in which implementations of the present disclosure may be employed. In particular, FIG. 11 shows a high level architecture of an example cloud computing platform 1110 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support a distributed computing environment 1100 that includes a cloud computing platform 1110, a rack 1120, and a node 1130 (e.g., computing devices, processing units, or blades) in rack 1120. The technical solution environment can be implemented with cloud computing platform 1110, which runs cloud services, such as cloud computing applications, across different data centers and geographic regions. Cloud computing platform 1110 can implement fabric controller 1140 component for provisioning and managing resource allocation, deployment, upgrade, and management of cloud services. Typically, cloud computing platform 1110 acts to store data or run service applications in a distributed manner. Cloud computing platform 1110 in a data center can be configured to host and support operation of endpoints of a particular service. Cloud computing platform 1110 may be a public cloud, a private cloud, or a dedicated cloud.

Node 1130 can be provisioned with host 1150 (e.g., operating system or runtime environment) running a defined software stack on node 1130. Node 1130 can also be configured to perform specialized functionality (e.g., compute nodes or storage nodes) within cloud computing platform 1110. Node 1130 is allocated to run one or more portions of a service application of a tenant. A tenant can refer to a customer utilizing resources of cloud computing platform 1110. Service application components of cloud computing platform 1110 that support a particular tenant can be referred to as a multi-tenant infrastructure or tenancy. A cloud service may comprise any software, or portions of software, that run on top of, or access storage and computing device locations within, a datacenter.

When more than one separate service application is being supported by nodes 1130, nodes 1130 may be partitioned into virtual machines (e.g., virtual machine 1152 and virtual machine 1154). Physical machines can also concurrently run separate service applications. The virtual machines or physical machines can be configured as individualized computing environments that are supported by resources 1160 (such as computer resources, which may comprise hardware resources and/or software resources) in cloud computing platform 1110. It is contemplated that resources 1160 can be configured for specific service applications. Further, each service application may be divided into functional portions such that each functional portion is able to run on a separate virtual machine. In cloud computing platform 1110, multiple servers may be used to run service applications and perform data storage operations in a cluster. In particular, the servers may perform data operations independently but exposed as a single device, referred to as a cluster. Each server in the cluster can be implemented as a node.

Client device 1180 may be linked to a service application in cloud computing platform 1110. Client device 1180 may be any type of computing device, such as user device 102n described with reference to FIG. 1, and the client device 1180 can be configured to issue commands to cloud computing platform 1110. In embodiments, client device 1180 may communicate with service applications through a virtual Internet Protocol (IP) and load balancer or other means that direct communication requests to designated endpoints in cloud computing platform 1110. The components of cloud computing platform 1110 may communicate with each other over a network (not shown), which may include one or more LANs and/or WANs.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of aspects of the present disclosure is described with specificity herein to meet statutory requirements. However, the description itself is not intended to limit the scope of this patent. Rather, it is contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “set” may be employed to refer to an ordered (i.e., sequential) or an unordered (i.e., non-sequential) collection of objects (or elements), such as machines (e.g., computer devices), physical and/or logical addresses, graph nodes, graph edges, functionalities, and the like. As used herein, a set may include N elements where N is any positive integer. That is, a set may include 1, 2, 3, . . . N objects and/or elements, where N is a positive integer with no upper bound. Therefore, as used herein, a set does not include a null set (i.e., an empty set), that includes no elements (e.g., N=0 for the null set). A set may include only a single element. In other embodiments, a set may include a number of elements that is significantly greater than one, two, three, or billions of elements. A set may be an infinite set or a finite set. The objects included in some sets may be discrete objects (e.g., the set of natural numbers N). The objects included in other sets may be continuous objects (e.g., the set of real numbers R). In some embodiments, “a set of objects” that is not a null set of the objects may be interchangeably referred to as either “one or more objects” or “at least one object,” where the term “object” may stand for any object or element that may be included in a set. Accordingly, the phrases, “one or more objects” and “at least one object” may be employed interchangeably to refer to a set of objects that is not the null or empty set of objects. A set of objects that includes at least two of the objects may be referred to as “a plurality of objects.”

As used herein, the terms “source code” and “code” may be used interchangeably to refer human-readable instructions that at least partially enable the execution of a computer application. Source code maybe encoded in one or more programming languages, e.g., Fortran, C, C++, Python, Ruby, Julia, R, Octave, Java, JavaScript, and the like. In some embodiments, prior to enabling an execution of a computer application, source code may be subjected to a compilation and/or linking process. As used herein, the term “executable” may refer to any set of machine instructions that instantiate a copy of a computer application and enable the one or more computing machines (e.g., a physical or virtual machine) to execute, run, or otherwise implement the instantiated application. A computer application may include a set of executables. An executable may be a binary executable, e.g., a set of executable machine instructions generated via the compilation of human-readable source code (in a programming language) and linking of the binary objects generated via the compilation. That is, an executable for a computer application may be generated via compiling the source code for the computer application. Although the embodiments are not so limited, a computer application may include human-readable source code, e.g., applications generated via interpreted programming languages. For instance, an executable for the computer application may include the source code for the computer application. An executable may include one or more binary executables, one or more source code-based executables, or any combination thereof. An executable may include and be dependent upon one or more libraries of functions, objects, or the like. An executable may be encoded in a single file, or the encoding may be distributed across multiple files. That is, an encoding of an executable may be distributed across a plurality of files. The encoding may include one or more data files, where the execution of the computer application may be dependent upon reading and/or writing to the one or more data files.

For purposes of a detailed discussion above, embodiments of the present disclosure are described with reference to a computing device or a distributed computing environment; however the computing device and distributed computing environment depicted herein is merely illustrative. Moreover, the terms computer system and computing system may be used interchangeably herein, such that a computer system is not limited to a single computing device, nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computing system comprising:
a processor; and
computer storage memory having computer-executable instructions stored thereon that, when executed by the processor, configure the computing system to perform operations comprising:
receive an insight request comprising an indication of a content item for which an item insight, corresponding to the content item, is to be determined;
based on an indication of the content item in the insight request, determine a collaboration network that is associated with the content item and a user;
generate a collaboration network indicator corresponding to the content item, the collaboration network indicator indicating at least an aspect of the collaboration network;
cause to present, with presentation of an indication of the content item, at least the collaboration network indicator.

2. The computing system of claim 1, wherein the operations further comprise:
determine an item context associated with the content item, the item context indicating a status of the content item relative to the user;
generate an item context indicator indicating the determined item context; and
cause to present, with presentation of an indication of the content item, the item context indicator.

3. The computing system of claim 2, wherein the collaboration network indicator and the item insight indicator are caused to be presented in a card that includes the presentation of the indication of the content item.

4. The computing system of claim 1, wherein the insight request is generated based on a determination by an item insight service, which is a computer service operating on the computing system, to obtain an item insight for the content item.

5. The computing system of claim 1, wherein the insight request is received from a computer application operating on the computing system, and based on an indication of the content item by the computer application.

6. The computing system of claim 5:
wherein the computer application comprises one of a data feed application, a file manager application, or communications application, or a search application;
wherein, for the data feed application, the collaboration network indicator is caused to be presented in a card comprising the presentation of the indication of the content item, the card being provided to the user via the data feed application; and
wherein, for the file manager application, the search application, or the communications application, the collaboration network indicator is caused to be presented proximate the presentation of the indication of the content item.

7. The computing system of claim 1:
wherein the collaboration network includes a set content items and a set of entities associated with the set of content items, the set of entities including one or more people who contributed to or have access to at least a portion of the set of content items; and
wherein the collaboration network associated with the content item and user is determined based on accessing collaboration network data comprising indications of at least one collaboration network, and determining the collaboration network that includes the content item and the user.

8. The computing system of claim 7, wherein the aspect of the collaboration network indicated by the collaboration network indicator comprises at least a portion of the set of entities associated with the set of content items.

9. The computing system of claim 1, wherein the content item comprises a document, a file, an email, an instant message, a text message, a calendar event, an indication of another user, or a search result.

10. The computing system of claim 2, wherein the status of the content item comprises information indicating a change or no change of the content item, change or no change of metadata associated with the content item, access or non-access of the content item by the user or by another person, or an action associated with the content item that is taken or not taken.

11. A computer-implemented method comprising:
accessing a set of collaboration network data, the collaboration network data including a first collaboration network associated with a user and having a first set of related content items and an indication of a first set of entities associated with the first set of related content items, and including a second collaboration network associated with the user and having a second set of related content items and an indication of a second set of entities associated with the second set of related content items;
determining, based on at least a portion of the set of collaboration network data, the item of content is included in the first collaboration network;
generating a collaboration network indicator that indicates an aspect of the first collaboration network;
causing display, via a graphical user interface and with a presentation of an indication of the item of content, the collaboration network indicator.

12. The method of claim 11, wherein the collaboration network indicator is presented via a card displayed in a data feed associated with the user, the card including the indication of the content item.

13. The method of claim 11, wherein the collaboration network indicator is presented to provide context based on the user selection of the item of content displayed in the graphical user interface.

14. The method of claim 11, wherein the aspect of the collaboration network indicated by the collaboration network indicator comprises at least a portion of the first set of entities.

15. The method of claim 11, wherein the first set of related content items comprise documents, files, media, emails, instant messages, text messages, or a combination thereof.

16. The method of claim 11:
wherein the set of collaboration network data is accessed in response to receiving, from a computer application, an insight request comprising an indication of the item of content;
wherein the computer application comprises one of a data feed application, a file manager application, or communications application, or a search application;
wherein, for the data feed application, the collaboration network indicator is displayed in a card that displays the indication of the item of content, the card being provided to the user via the data feed application; and
wherein, for the file manager application, the search application, or the communications application, the collaboration network indicator is displayed proximate the presentation of the indication of the item of content.

17. A computer-implemented method for presenting insights in a graphical user interface that is operating on a computer system, the method comprising:
causing display, via the graphical user interface, of an indication of an item of content;
causing display, via the graphical user interface, of a collaboration network insight associated with the item of content, the collaboration network insight comprising an indication of at least an aspect of a collaboration network associated with a user and having a set of content items related to one another and a set of entities associated with the set of content items; and
causing display, via the graphical user interface, of an item context insight associated with the item of content, the item context insight comprising information regarding a status of the item of content relative to the user.

18. The method of claim 17, wherein the graphical user interface presents aspects of a data feed including a card, and wherein the collaboration network insight and the item context insight are automatically presented in the card with an indication of the item of content.

19. The method of claim 17, wherein the collaboration network insight or the item context insight is presented subsequent to receiving an insight request that is generated based on a user interaction with the item of content via the graphical user interface; and wherein the aspect of the collaboration network comprises at least a portion of the set of entities.

20. The method of claim 16, wherein the graphical user interface comprises one of a card in a data feed, a file manager application interface, or an electronic communications application interface, and wherein the indication of the item of content, the collaboration network insight, and the item context insight are concurrently presented.
